(19) United States
(12) Patent Application Publication
(10) Pub. No.: US 2006/0163169 A1
(43) Pub. Date: Jul. 27, 2006

(54) Methods and apparatus for the treatment of fluids

(76) Inventors: Richard A. Eckhardt, Arlington, MA (US); Geoffrey H. Jenkins, Wellesley Hills, MA (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/302,483

(22) Filed: Dec. 13, 2005

Related U.S. Application Data
(60) Provisional application No. 60/635,494, filed on Dec. 13, 2004.

(51) Int. Cl. C02F 1/32; C02F 9/12

(52) U.S. Cl. 210/748; 210/282; 210/266; 210/449

(57) ABSTRACT

Methods and apparatus for disinfecting and/or filtering fluids, such as water, are disclosed. One embodiment is directed to a method of providing treated fluid, comprising acts of receiving the fluid into a chamber, filtering the fluid of particulate matter and/or chemicals within the chamber, disinfecting the fluid with an ultraviolet light source within the chamber, and dispensing the fluid from the chamber. Methods and apparatus for improving the efficiency of a light source, such as a light source used for ultraviolet disinfection, are also disclosed. Another embodiment is directed to an improved-efficiency ultraviolet disinfection device, comprising a chamber, and a black body radiator disposed therein and adapted to emit light in the ultraviolet spectrum. At least a portion of the chamber is constructed and arranged to reflect an amount of emitted light that is sufficient to cause regenerative heating of the black body radiator back toward the black body radiator.

### PRIORITY CLAIM

This application claims the benefit, under 35 U.S.C. §119(e), of the filing date of U.S. provisional application Ser. No. 60/635494 entitled “Method and Apparatus for UV Light Disinfection and Filtering of Fluids,” filed Dec. 13, 2004, which is incorporated herein by reference.

### FIELD OF THE INVENTION

The present invention relates generally to the field of disinfection and/or filtering of fluids.

### BACKGROUND OF THE INVENTION

There are many reasons for filtering and/or disinfecting water or other fluids. Probably the most common reason is for human consumption. In some applications, simple filtering of particulates and/or chemicals is sufficient to treat water, but in many cases there is also a concern for the presence of microbes in the water. Although it is possible to filter most microbes out of water, it requires a special micro pore filter and very high pressure to force the water through the filter. The micro pore filters tend to plug-up quickly and in many applications, the high pressure is inconvenient or very difficult to achieve. This is the case, for example, in portable applications for use by travelers, hikers, or people in under-developed areas or countries. This technique is also inconvenient to use in the home where the system for generating the high pressure would be expensive, and difficult to install and use. An alternative means of addressing the concern of microbes in water is to add chemicals to the water. This can adversely affect the taste of the water, and many of the chemicals used kill only bacteria and have little or no effect on viruses.

Another existing technique for addressing microbes in water is treatment with ultraviolet (UV) light. With sufficient dosage in the correct spectrum, UV light can inactivate most microbes, including bacteria, viruses, molds fungus, etc. The inactivated microbes (considered clinically dead) may not be killed outright, but they are unable to reproduce and therefore cannot cause an infection. However, presently used methods and apparatus for UV disinfection of water require long exposure times and significant power, or may only be used for small quantities. Thus, these methods and apparatus are not suitable for many applications.

### SUMMARY OF THE INVENTION

One embodiment of the invention is directed to a method of providing treated fluid. The method comprises acts of receiving the fluid into a chamber, filtering the fluid of at least some particulate matter and/or chemicals within the chamber, disinfecting the fluid with an ultraviolet light source within the chamber, and dispensing the fluid from the chamber.

Another embodiment of the invention is directed to a faucet-coupleable device for treating fluid. The device comprises a housing adapted to be coupled to a faucet such that the housing may receive fluid from the faucet, a filter disposed within the housing to filter the fluid of at least some particulate matter and/or chemicals, an ultraviolet light source disposed within the housing to disinfect the fluid, and an outlet port to release the fluid.

A further embodiment of the invention is directed to a fluid dispenser, comprising a receptacle to hold fluid, the receptacle having a first opening for receiving fluid and a second opening for dispensing fluid, a passage between the first opening and the second opening for allowing the passage of fluid between the first opening and the second opening, a filter configured and arranged to filter the fluid of at least some particulate matter and/or chemicals as the fluid passes through the passage, and an ultraviolet light source configured and arranged to disinfect the fluid in at least a portion of the receptacle.

Another embodiment of the invention is directed to a bottle for holding and treating fluid. The bottle comprises a receptacle for holding the fluid, a filtering unit constructed to be receivable within the receptacle, the filtering unit comprising a filter, wherein the filtering unit is constructed such that insertion of the filtering unit into the receptacle causes fluid disposed within the receptacle to pass through the filter.

A further embodiment of the invention is directed to an improved-efficiency ultraviolet disinfection device. The device comprises a chamber and a black body radiator disposed within the chamber, wherein the black body radiator is adapted to emit light in the ultraviolet spectrum. At least a portion of the chamber is constructed and arranged to reflect an amount of light emitted by the black body radiator back toward the black body radiator such that the reflected light is incident upon the back body radiator. The amount is sufficient to cause regenerative heating of the black body radiator.

Another embodiment of the invention is directed to a method of improving the efficiency of a black body radiator disposed within a housing, and adapted to emit light in the ultraviolet spectrum. The method comprises acts of emitting light of both desirable and undesirable wavelengths from the black body radiator, transmitting the light of desirable wavelengths through the housing, reflecting the light of undesirable wavelengths off the housing and towards the black body radiator, and using the reflected light of undesirable wavelengths, causing regenerative heating of the black body radiator.

A further embodiment of the invention is directed to a replaceable module for a faucet-mountable treatment device. The module comprises a filter adapted to filter a fluid of at least some particulate matter and/or chemicals and a reflective material disposed on the filter. The coating is adapted to reflect light in the ultraviolet range.

### BRIEF DESCRIPTION OF THE DRAWINGS

FIGS. 1A and 1B show an illustrative embodiment of an improved-efficiency UV light source;

FIG. 2 shows another illustrative embodiment of an improved-efficiency UV light source;

FIGS. 3A and 3B show one illustrative embodiment of an improved-efficiency UV disinfection apparatus;

FIG. 4 shows an illustrative embodiment of an improved-efficiency UV disinfection apparatus;

FIGS. 5A and 5B show a further illustrative embodiment of an improved-efficiency UV disinfection apparatus;

FIGS. 6A-6D show an illustrative embodiment of a bottle for filtering and disinfecting water or other fluids, and a method of using the same;

FIG. 7 shows an exemplary circuit that may be used to drive the light source of various embodiments disclosed herein;

FIGS. 8A and 8B show an illustrative embodiment of a pitcher for filtering and disinfecting water or other fluids;

FIGS. 9A and 9B show another illustrative embodiment of a pitcher for filtering and disinfecting water or other fluids;

FIGS. 10A and 10B show a further illustrative embodiment of a pitcher for filtering and disinfecting water or other fluids;

FIGS. 11A and 11B show illustrative embodiments of other applications of the receptacle shown in FIGS. 8A-8B;

FIGS. 12A and 12B show an illustrative embodiment of a faucet-mountable device for filtering and disinfecting water or other fluids;

FIG. 13 shows an exemplary placement of a transducer that may be used in the faucet-mountable device of FIGS. 12A and 12B;

FIGS. 14A-14D show an illustrative embodiment of a straw-mountable device for disinfecting water or other fluids;

FIGS. 15A-15D show a method of using the stabilizer of FIG. 14D;

FIGS. 16A-16D show an illustrative embodiment of a shut-off mechanism that may be provided in a straw-mountable device; and

FIGS. 17A and 17B show another illustrative embodiment of a straw-mountable device for disinfecting water or other fluids.

### DETAILED DESCRIPTION

One aspect of the invention is directed to methods and apparatus for disinfecting and/or filtering fluids, such as water. Another aspect of the invention is directed to improving the efficiency of a light source. Although these aspects of the present invention are advantageously employed together in accordance with several illustrative embodiments of the invention, the present invention is not limited in this respect, as each of these aspects of the present invention can also be employed separately.

Improved Efficiency Light Sources and Disinfection Chambers

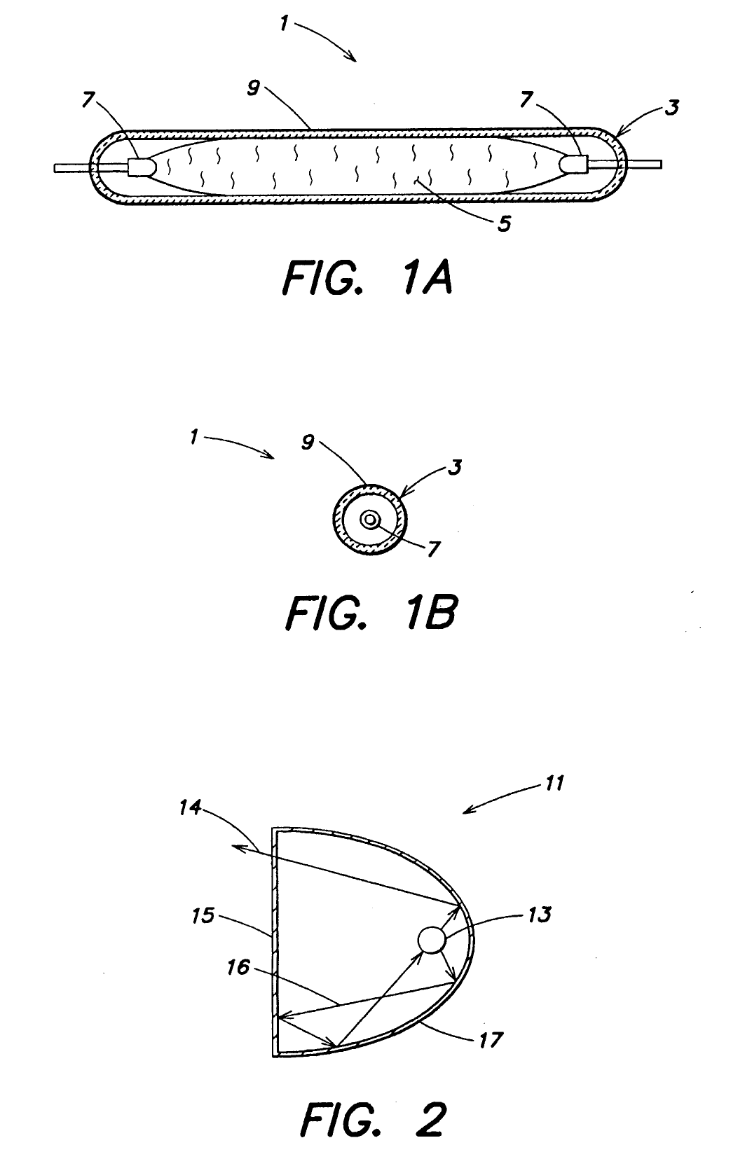

One aspect of the invention, described in connection with FIGS. 1-5, is directed to methods and apparatus for improving the efficiency of a light source. Specifically, the efficiency of a black body ultraviolet (UV) light source may be improved by redirecting light emitted by the light source back towards the light source. The efficiency of the light source may be increased significantly in this manner, e.g., by 20, 30, 50, 100, or 200 percent. According to some embodiments, the UV light source is disposed within a UV disinfection apparatus constructed to promote regenerative heating of the light source.

One illustrative embodiment of an improved-efficiency UV light source is shown in FIGS. 1A and 1B, which show a cross sectional side view and a cross-sectional end view of the UV light source, respectively. As shown, a UV light source 1 includes an envelope 3 enclosing a gas 5. Electrodes 7 are provided within the UV light source 1 to allow an electric current to pass between the electrodes 7 through the gas 5. The current ionizes the gas 5, forming a plasma that emits light at least partially in the UV range. The envelope 3 is configured such that some of the light generated by the gas plasma is transmitted through the envelope and some of the light generated is reflected back to the gas 5, where it is absorbed and returns the energy to the gas as heat. Returning this heat to the gas 5 provides the same benefit as passing more current through the gas to raise its temperature. Accordingly, less current is required to maintain the same gas temperature, resulting in an improvement in the efficiency of the UV light source.

According to one exemplary implementation, the UV light source 1 is a high energy gas discharge lamp. The gas 5 of the UV light source 1 may be xenon, although other gases or mixtures of gases are possible. The UV light source 1 may be a flash lamp, which emits light in flashes, or a continuous lamp, which emits light continuously. Although light source 1 and other light sources herein are described as a UV light source, it should be appreciated that while at least a portion of the generated light is in the UV range (e.g., wavelengths of 160 to 400 nanometers), some generated light may be in one or more other ranges. For example, the UV light source 1 may produce light in the infrared, visible, and UV light ranges. For UV light disinfection applications, at least some of the emitted UV light may be germicidal. The most effective germicidal UV light is in the wavelength range of 200 to 315 nanometers, although light outside this band may have some germicidal effect, or be effective on some organisms. For purposes of this application, the term “disinfect” refers to the destruction or prevention of growth of microorganisms. The disinfection may achieve a desired level (e.g., high, as is the case with sterilization, or low) of disinfection. The disinfection may occur by killing microorganisms, inactivating microorganisms (i.e., rendering the microorganisms unable to reproduce), or any combination thereof.

As discussed previously, the envelope 3 is configured such that some of the light generated by the gas plasma is transmitted through the envelope, and some of the light generated is reflected back to the gas 5, where it is absorbed and returns the energy to the gas as heat. According to one exemplary implementation, which may be advantageously employed in disinfection applications of the UV light source 1, the envelope 3 is configured to transmit germicidal UV light and reflect back light of at least some other wavelengths to the gas 5. The reflected light may be light of unneeded or unnecessary wavelengths, such as visible light, which is not needed for disinfection. In the exemplary implementation of FIGS. 1A and 1B, the envelope 3 comprises a dichroic filter/reflector coating 9 that passes germicidal UV light (e.g., shorter than 315 nanometers wavelength) and reflects the other wavelengths of light (e.g., longer than 315 nanometers wavelength). It should be appreciated that reflected light may be reflected back several times before being absorbed by the gas.

To maximize the output of germicidal ultraviolet light from the UV light source 1, the envelope 3 may constructed from UV light transmitting glass or quartz. Further, the envelope 3 may be configured to stop undesired wavelengths of UV light (e.g., less than 200 or 220 nanometers), for example by including a selectively light-absorbent coating. This may be done, for example, to prevent ozone generation.

Although UV light source 1 is described above as having a continuous emission spectrum, the UV light source may instead have a line emission spectrum. In this case, the UV light source 1 may have one or more emission lines at a wavelength not needed or beneficial for the application of the UV light source. For example, the UV light source 1, if used in a disinfection apparatus, may have one or more emission lines at a non-germicidal wavelength. Thus, the dichroic filter/reflector coating 9 may reflect the light at the unneeded wavelengths back to the gas where it is absorbed after one or more reflections. This returns the energy to the gas where it is re-emitted as light, enhancing the light production at one or more desired wavelengths.

An alternative embodiment of an improved-efficiency UV light source is shown in cross-section in FIG. 2. The UV light source 11 of FIG. 2 uses the same principles as the UV light source 1 of FIGS. 1A and 1B to improve the efficiency thereof, but is generally easier to manufacture. The UV light source 11 includes a lamp 13, a planar dichroic filter/reflector 15, and an elliptical or parabolic reflector 17. The elliptical or parabolic reflector 17 may have a uniform elliptical or parabolic cross section. The planar dichroic filter/reflector 15 is positioned perpendicular to the central axis of the elliptical or parabolic reflector 17 such that the light reflected by the planar dichroic filter/reflector 15 will be returned to lamp 13. The lamp 13 may have a cylindrical shape, and may be located along a line focus of the elliptical or parabolic reflector 17 to increase the incidence of reflected light upon the lamp 13.

The lamp 13 may be a gas discharge lamp that emits light as a black body radiator. According to one exemplary implementation, the lamp 13 is a xenon flash lamp. The lamp 13 may emit light in flashes or continuously, and may have a continuous or line emission spectrum. Further, the lamp 13 may emit both desired and desired wavelengths. For example, for disinfection applications of the UV light source 11, the desired wavelengths may include germicidal wavelengths of UV light.

As with the envelope 3 of FIGS. 1A and 1B, the planar dichroic filter/reflector 15 is configured such that a portion 14 of the light emitted by lamp 13 (e.g., desired wavelengths) is transmitted through the planar dichroic filter/reflector 15 and a portion 14 of the light generated (e.g., undesired wavelengths) is reflected back to the gas of the lamp 13, where it is absorbed and returns the energy to the gas as heat. The planar dichroic filter/reflector 15 may have any of the properties described in connection with the dichroic filter/reflector coating 9 described in connection with FIGS. 1A and 1B.

Although the invention is not limited in this respect, either of the UV light sources 1 and 11 of FIGS. 1-2 may be used in an apparatus for disinfection. For example, the UV light sources 1 and 11 may be used in an apparatus to disinfect fluids. Alternatively, a disinfection apparatus may be constructed that does not include a dichroic filter/reflector. Thus, the disinfection apparatus may be easier and less expensive to manufacture than a disinfection apparatus including either of the UV light sources 1 and 11 of FIGS. 1-2.

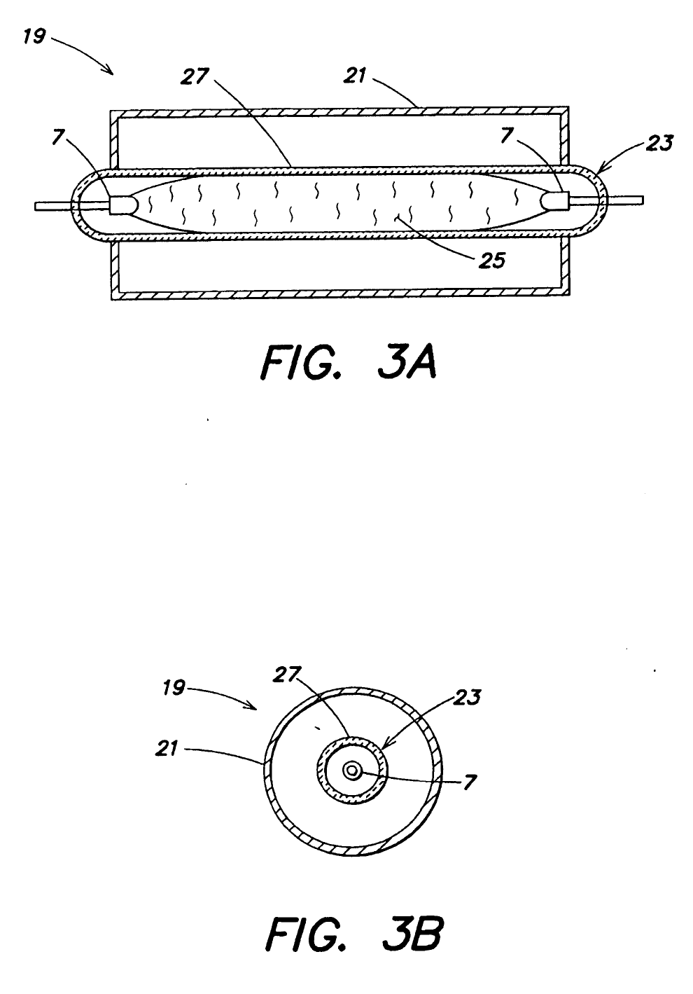

One illustrative embodiment of an improved-efficiency UV disinfection apparatus is shown in FIG. 3A and 3B, which respectively show cross-sectional views of the side and end of the apparatus. The apparatus 19 comprises a chamber 21 having a cylindrical shape and a UV lamp 23, which may be a gas discharge lamp that emits light as a black body radiator. The inner walls of the chamber 21 are configured to reflect light emitted by the UV lamp 23. Thus, the efficiency of the UV lamp 23 may be improved by redirecting UV light emitted by the UV lamp 23 back towards the light source, as discussed in connection with FIGS. 1A-1B.

In this embodiment, the object(s) or material to be disinfected is placed inside a reflective chamber 21. The chamber 21 is configured to return the light from the UV lamp 23 back to the lamp if the light is not absorbed or deflected by the objects or material in the chamber. Thus, the inner walls of the chamber 21 may be configured to reflect a broad spectrum of light (e.g., from infrared to UV light). According to one exemplary implementation, the reflector may be designed to reflect as much of the output spectrum of the lamp as is practical. For example, the inner walls of the chamber 21 may be constructed of aluminum. Alternatively, the inner walls of the chamber 21 may comprise another material (e.g., plastic or glass) and may be coated with aluminum or otherwise have aluminum disposed thereon. The aluminum, in turn, may be coated with a UV-transparent coating to enhance the reflectance of the walls, and to protect the aluminum from contact with the fluid and any resulting corrosion or abrasion. Exemplary materials that may be used for the transparent coating include magnesium fluoride, silicon dioxide, and aluminum oxide. Some polymers, such as polyethylene and Teflon have sufficient transparency to germicidal UV light for use as a coating when applied in a thin layer (e.g., less than 0.01 inches). The light that is returned to the lamp 23 provides regenerative heating of gas 25 in the lamp 23 and, as previously described, increases the efficiency of the lamp 23 for UV light production.

A high energy gas discharge lamp that emits ultraviolet light may be used for this application. The lamp 23 preferably has a cylindrical envelope 27, to take advantage of the light that will be reflected back to the lamp 23 from the chamber 21. The lamp 23 may emit light in flashes or continuously, and may have a continuous or line emission spectrum. To enable disinfection of the contents of the chamber 21, at least some of the light emitted by lamp 23 is germicidal UV light. According to one exemplary implementation, the lamp 23 is a xenon flash lamp.

One exemplary application of the disinfection apparatus 19 is the disinfection of fluids (e.g., water or air). The fluid to be disinfected can fill some or all of the volume between the walls of the chamber 21 and the lamp 23, and may be stationary or flowing. If the fluid to be disinfected allows light emitted by the lamp 23 to be transmitted through it, the light is then reflected back to the lamp to recover some of its energy in the form of additional heating of the gas that produces the light.

Since the gas in the lamp is not completely opaque, some of the reflected light will pass through the lamp 23 and into the fluid volume on the other side of the lamp. The light will contribute to the disinfection in the fluid and be reflected again from the walls of the chamber 21. Each reflection and pass through the fluid of the light will be associated with some losses, but the multiple passes through the fluid will increase the total UV energy density for disinfection. This configuration may be combined with the dichroic filter techniques describes in connection with FIGS. 1-2 to reflect the unneeded wavelengths before they pass through the contents of the chamber 21, and thereby reduce energy loss.

Although the disinfection apparatus shown in FIG. 3 uses a cylindrical reflector, other reflector configurations may be used. For example, the elliptical or parabolic reflector 17 and lamp 13 of FIG. 2 may be used with a planar reflector positioned perpendicular to the central axis of the elliptical or parabolic reflector to form a disinfection apparatus. The disinfection apparatus could be used to disinfect objects or other materials disposed on the planar reflector within the apparatus. Preferably the objects or other materials would be planar in shape such that any light reflected directly off the objects or other materials would return to the lamp.

Another embodiment of an improved-efficiency UV disinfection apparatus is shown in cross-section in FIG. 4. The apparatus 29 is similar to the apparatus of FIG. 3, but includes a different chamber configuration. Specifically, chamber 31 comprises a parabolic reflector 33 having a uniform cross-section and a planar reflector 35 positioned perpendicular to the central axis of the parabolic reflector 33. A lamp 37, similar to the lamp disclosed in connection with the embodiment of FIG. 4, may have a cylindrical shape and be located along the line focus of the parabolic reflector 33. In this configuration, the light that strikes the parabolic reflector 33 is directed into substantially parallel rays 39 that travel down the length of the chamber 31. The planar reflector 35 sends the light rays 39 back in the direction they came from. The light rays will then strike the parabolic reflector 33 and be focused back onto the lamp 37 to provide regenerative heating of the gas in the lamp 37. The side walls 41 of the chamber 31 are preferably also reflective, so any light that hits the side walls will be reflected back through the chamber to increase the total amount of UV light that is applied to the material to be disinfected, and some of this light will also be returned to the lamp for regenerative heating.

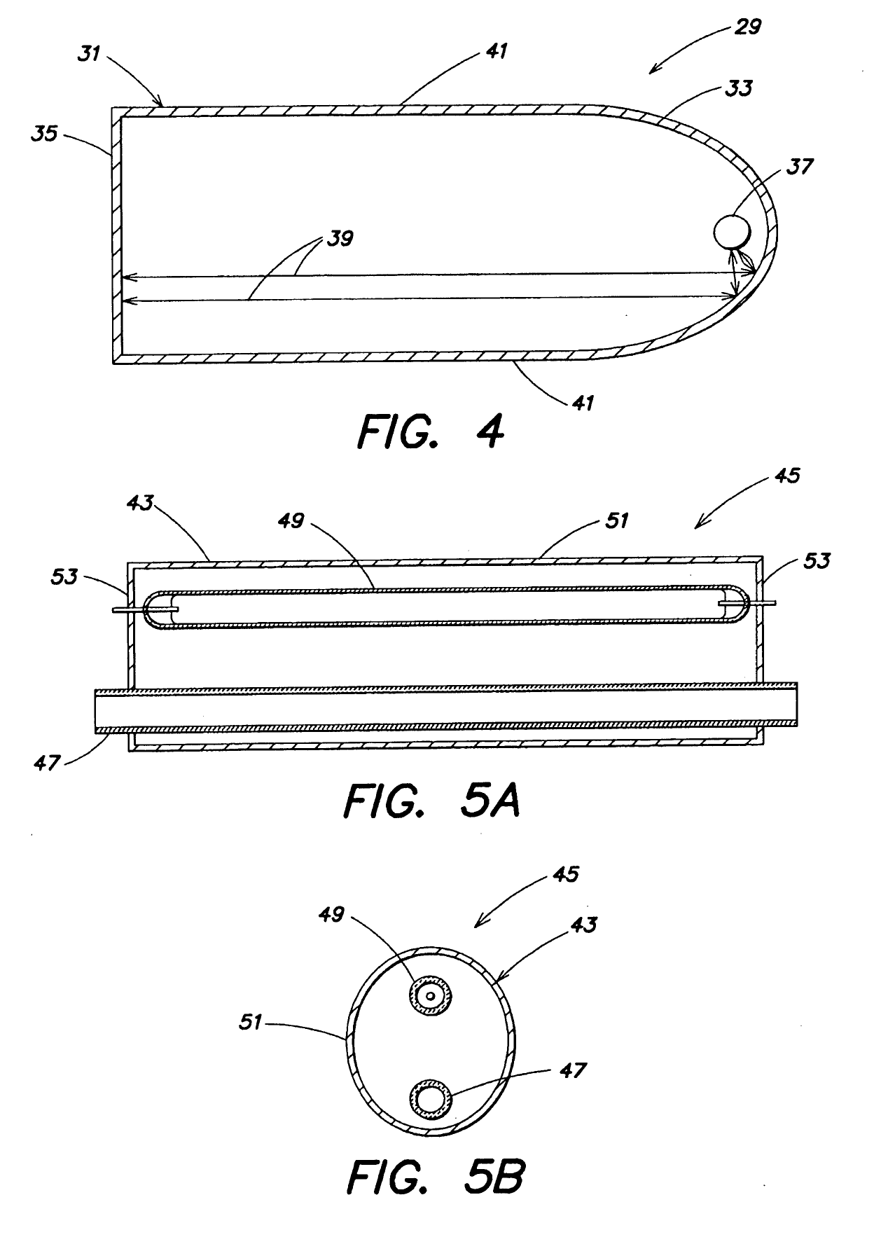

A further embodiment of an improved-efficiency UV disinfection apparatus is shown in FIGS. 5A and 5B, which show a cross sectional side and end views of the apparatus, respectively. A chamber 43 of UV disinfection apparatus 45 comprises an ellipsoidal reflector 51, which has a uniform elliptical cross-section. A cylindrical tube 47 for carrying a fluid is disposed along one line focus of the ellipsoidal reflector 51 and a cylindrical lamp 49 is disposed along the other line focus of the ellipsoidal reflector 51. Lamp 49 and ellipsoidal reflector 51 may have any of the properties discussed in connection with prior embodiments of the UV disinfection apparatus 45. The tube 47 is comprised of a UV transmissive material such as quartz or UV transmissive glass. The ellipsoidal reflector 51 focuses the light from the lamp 49 on the tube 47. The light passes through the tube 47 and the fluid therein to disinfect the fluid. The light that is not absorbed continues through the tube 47 to strike the ellipsoidal reflector 51 where it is directed back to the lamp 49 to create the regenerative heating. Light that passes through the lamp 49 strikes the ellipsoidal reflector 51 and is directed back to the tube 47. Planar end reflectors 53 may included at the ends of the chamber 43 to direct light that strikes the end reflectors back into the chamber 43 and to either the lamp 49 or the tube 47.

These are a few examples of how regenerative heating of a lamp with unabsorbed reflected light can be used to improve the efficiency of the production of the desired light. Those skilled in the art can readily see that there are a wide variety of different configurations, lamp types, and applications for this technology to improve the efficiency of an illumination system by regenerative heating of the lamp with the unused light from the lamp.

Bottle for Treating Fluids

One common application for fluid (e.g., water) filtration and/or disinfection is for travelers. This includes hikers, campers, climbers, military personnel, and other people traveling in the wilderness areas. It also includes people traveling in under-developed areas or countries, or in any area where the water is of unknown quality. For this application, a portable water filtration and/or disinfection device that is convenient to use and that does not require chemicals is desirable.

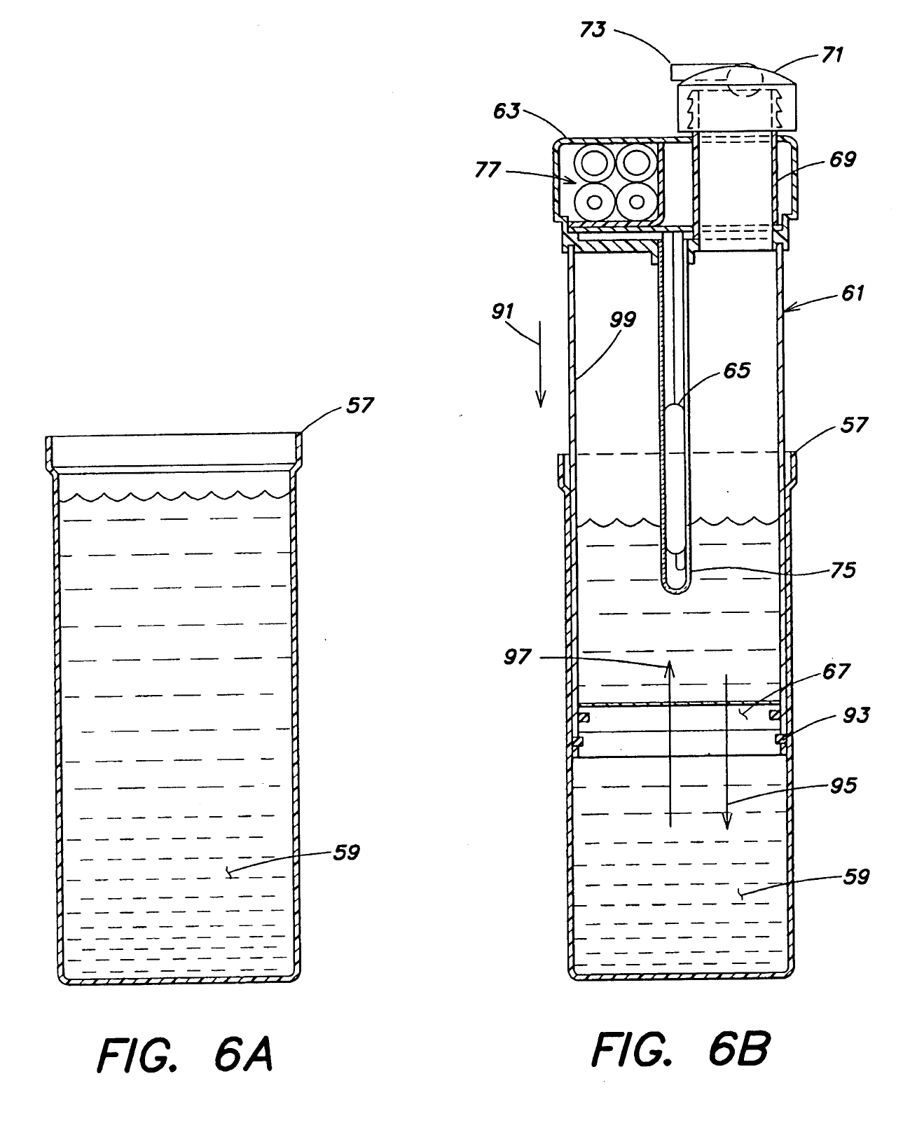

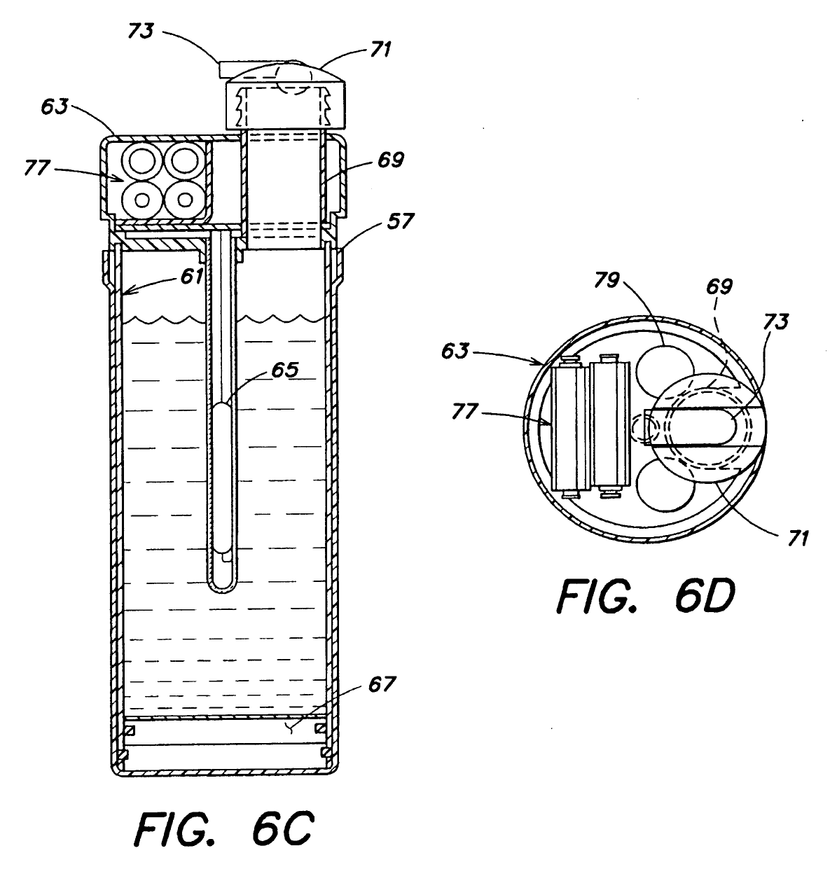

One illustrative embodiment of a bottle for filtering and disinfecting water or other fluids, and a method of using the same, is shown in FIGS. 6A-6D, which show cross sectional views of portions of the bottle during a filtration and/or disinfection process. The bottle includes a filter for filtering particulates and/or chemicals from a fluid and a UV light source for disinfecting the fluid. As shown, the bottle 55 includes a receptacle 57 for holding fluid 59, a filtering unit 61 constructed to be receivable within the receptacle 57, a cap 63 coupled to the filtering unit 61, and a UV light source 65.

The filtering unit 61 is sized and shaped to be receivable within the receptacle 57. According to one exemplary implementation shown in FIG. 6B, both the receptacle 57 and the filtering unit 61 have a cylindrical shape, with the filtering unit having a smaller diameter than the receptacle so as to fit within the receptacle. For example, the inner diameter of the receptacle 57 may be approximately equal to the outer diameter of the filtering unit 61 such that the filtering unit 61 is slidable within the receptacle 57.

A filter 67 is coupled to the bottom end of the filtering unit 61, and may have substantially the same diameter as the filtering unit. The filter 67 is constructed such that particulates and/or chemicals in a fluid passing therethrough will be prevented from traversing the filter. Further, the filter 67 is arranged such that all or substantially all of the fluid in the receptacle passes upward through the filter as the filter is moved downward through the receptacle.

The cap 63 is coupled to filtering unit 61, and is cylindrically shaped to correspond with the shape of the filtering unit. In the exemplary implementation shown, the cap 63 is secured to the filtering unit 61 via a cylindrical slot in the cap that interfaces with the upper portion of the cylindrical wall of the filtering unit. The cap 63 further comprises a spout 69 for drinking or pouring fluid from the bottle 55. The spout 69 may be provided with a screw cap 71 to allow the spout to be opened and closed, and a rotatable mouthpiece 73 thereon to allow fluid to be released from the spout 69 therethrough. However, the invention is not limited in this respect, as alternative or additional means of accessing the fluid may be provided. For example, the cap unit may be entirely removable from the filtering unit 61 to provide access to the fluid within the bottle 55. As another example, a portion of the cap may be removable via a screw mechanism or other mechanism to provide an opening to access the fluid that is larger than that provided by the spout 69. As yet another example, cap 63 may be coupleable to receptacle 57, rather than filtering unit 61, and may be removable from the receptacle to allow access to the fluid therein.

It should be appreciated that alternate configurations of the receptacle 57, filtering unit 61, and cap 63 may be provided in accordance with the invention. For example, the receptacle 57, filtering unit 61, and cap 63 need not be cylindrical, and may instead be provided in other shapes.

Although optional, the bottle shown in FIGS. 6A-6D further comprises means for disinfecting the fluid in the bottle 55. Specifically, a UV light source 65 is electrically coupled to the cap 63 for illuminating the fluid with UV light. According to the exemplary implementation shown, UV light source 65 is a cylindrical lamp coupled to the cap 63 such that the UV light source 65 extends along a longitudinal axis of the receptacle 57. A housing 75 is provided to enclose the UV light source 65, such that the UV light source does not come into direct physical contact with the fluid. The housing 75 is configured to transmit UV light, and may include safety features. For example, the housing 75 may be constructed of a shatter resistant or breakage resistant material. According to one exemplary implementation, the UV light source 65 is a cylindrical xenon flash lamp, although other shapes and types of UV light sources may alternatively be used.

A power source 77 is provided within the cap 63 to power the UV light source 65. In the example shown, the power source 77 comprises batteries that are fully enclosed within a portion of the cap 63. In addition, circuitry 79 is provided within the cap 63 to drive the UV light source 65. The cap 63 may be constructed to provide a fluid-tight environment for the power source 77 and the circuitry 79.

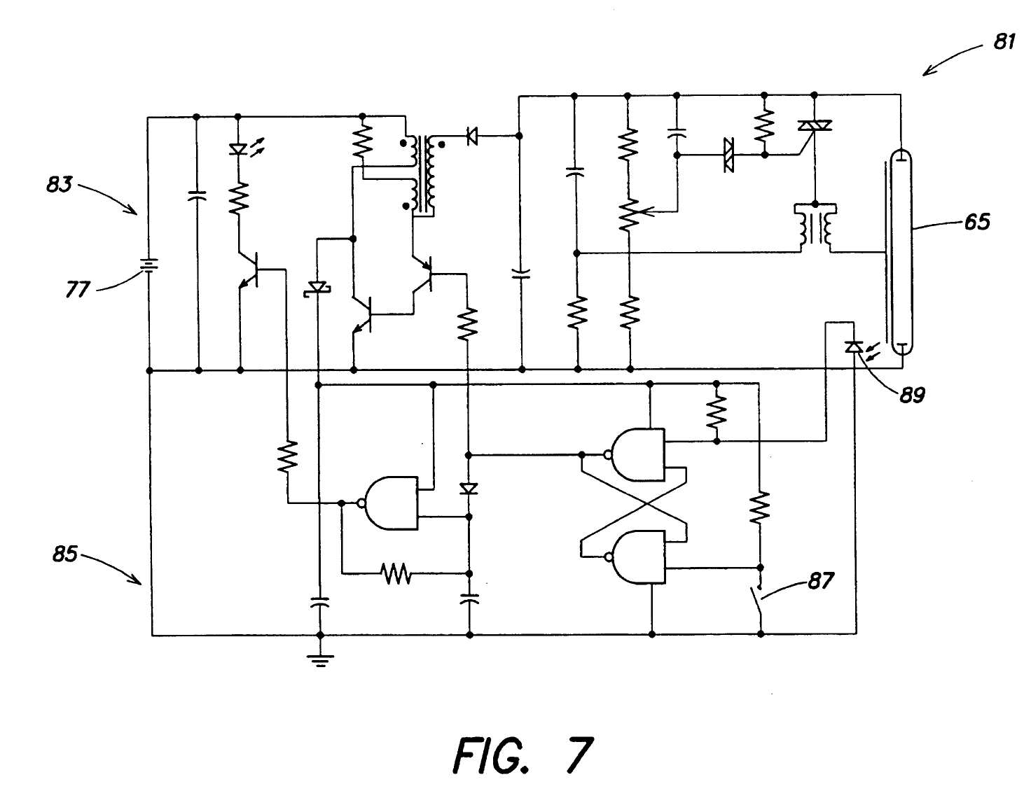

As discussed above, the UV light source 65 may, in one example, be a xenon flash lamp. The circuitry required to drive a xenon flash lamp is similar to that of a photographic flash unit. In general, the circuit must generate a high voltage, typically over 300 Volts, to charge a capacitor to hold the energy for the flash lamp. FIG. 7 shows an exemplary circuit that may be used for circuitry 79. Although the circuit 81 shown in FIG. 7 provides a single flash for each operation, the circuit could alternatively be constructed to deliver the required energy in more than one flash. The top portion 83 of the circuit 81 comprises a high voltage generator and a trigger circuit to initiate the flash when the charging is complete. The lower portion 85 of the circuit 81 comprises the logic to initiate the process when the “start” switch 87 is activated and to stop the charging when the flash has occurred. In addition, this circuit 81 comprises an optional lockout that prevents its operation when the bottle is open to prevent accidental operator exposure to emitted UV light. This lockout is created by the detection of ambient light by a phototransistor 89 when the bottle 55 is open. This creates the same condition as when the phototransistor 89 detects the flash to terminate the charging. Under this condition, the charging cannot start, or will stop if it is already in process. It should be appreciated that the circuit 81 is just one example of a circuit for driving a xenon flash lamp. Those skilled in the art will recognize that many other configurations are possible for performing this function.

It is also possible to use a power source other than batteries for the UV light source 65. For example, an electrical generator could be included that uses mechanical energy to create the electrical charge on the capacitor to drive the UV lamp. The generator could be powered by mechanical energy supplied by a user using, for example, a crank, a wind-up spring, or reciprocating motion. The mechanical energy could also be created by the action of pushing the filtering unit 61 into the receptacle 57. The energy could be directly mechanically coupled to a generator, or the flow of the fluid from the receptacle 57 to the filtering unit 61 could be harnessed, such as with a turbine to drive a generator. Alternatively, the air escaping from the filtering unit 61 as it is pressed into the receptacle 57 could be harnessed.

A method of using the bottle 55 to filter and disinfect fluid will now be described in connection with FIGS. 6A-6C. As shown in FIG. 6A, fluid is first placed in the receptacle 57. A “fill” line on the outer container can indicate the proper amount of fluid to use. Then, as shown in FIG. 6B, the filtering unit 61, with the filter 67 attached to the bottom, is pressed in a downward direction 91 into the receptacle 57. The filtering unit 61 forms a seal 93 to the inside wall of the receptacle 57 such that, as the filter 67 is pushed in a downward direction 95, the fluid 59 in the receptacle 57 is forced in an upward direction 97 through the filter 67 and into the filtering unit 61, thus filtering out particulates and/or chemicals, such as chlorine, hydrocarbons, etc. Pressing the filtering unit 61 into the receptacle 57 creates a significant pressure increase in the fluid for rapidly pushing the fluid through the filter 67. This configuration is much faster than systems that depend on gravity flow of the fluid, and is simpler, smaller, and less expensive than systems that include a separate pump. Once the filtering unit 61 is fully lowered into the receptacle 57, latches may secure the filtering unit to the receptacle to hold the receptacle in place.

The filter 67 may contain a check valve that requires a small positive pressure to actuate to allow fluid flow through the filter. This will eliminate any fluid exchange between the fluid in the filtering unit 61 and any fluid left in and below the filter 67 after the filtering operation. The filter 67 also may contain a second check valve from the bottom of the filter 67 to the outside of the filtering unit 61 above the seal 93 with the receptacle 57. This allows air to be drawn into the bottom of the receptacle 57 when the filtering unit 61 is withdrawn to refill the bottle.

The filter 67 is removably attached to the bottom of the filtering unit 61 to allow it to be replaced as it becomes plugged or consumed with use. This can be implemented in a number of ways, for example by small protrusions on the filter 67, which can engage hooks on the filtering unit with a slight rotation. When the filter 67 is installed at the bottom of the filtering unit 61, it may form a seal to receptacle to prevent fluid flow between the filtering unit and the receptacle 57 around the filter 67. FIG. 6B schematically shows the fluid flowing straight through the filter 67 from the bottom to the top. Depending on the filter type, it may be desirable to have the fluid flow through a longer path through the filter 67, for example with activated charcoal this would increase the dwell time of the fluid in the charcoal and the available surface area of the charcoal presented to the fluid.

The filter 67 may also contain a mechanism to measure its usage to provide an indication to the user when it is time to replace the filter 67. This mechanism could be a turbine that is turned by the fluid flow through the filter 67. The turbine may be then geared down to move a pointer to indicate the usage. The indicator could alternatively be actuated by the increase in pressure of the fluid at the filter 67 with each usage. This increase in pressure could trigger a ratchet that advances a pointer with each use. A direct mechanical actuation could also be used to advance the pointer as the filter 67 reaches the bottom of the receptacle 57. Similar mechanical or electrical sensing could also be done from the top of the bottle 55 where the edge of the top of the receptacle 57 could be detected mechanically, electrically, or optically. Each time the filtering unit 61 is seated into the receptacle 57, an electrical or mechanical indicator could be incremented. If the indicator is positioned on the filter 67, it is preferable to have it on the bottom of the filter so it is visible when the bottle 55 is filled without removing the filter from the filtering unit 61.

After the fluid has been transferred to the filtering unit 61, as shown in FIG. 6C, UV disinfection is performed. The filtering unit 61 may include a reflective inner surface 99 to produce regenerative heating of the UV light source 65 in the same manner as discussed in connection with the embodiment of FIGS. 3A and 3B. In FIG. 6, the UV light source 65 is shown as shorter than the overall length of the receptacle 57, such that some of the light from the UV light source 65 is reflected at an angle and not directly reflected back to the UV light source. For this reason, the bottom surface of the cap 63 and the top surface of the filter 67 may include a UV-reflective coating or other surface to cause the light to reflect through the fluid multiple times to increase the effectiveness and to return a portion of the light to the UV light source. Rather than the UV light source 65 shown, a UV light source running the full length of the filtering unit could be used for more efficient regenerative heating, although such a UV light source may have a higher initial cost. Increasing the efficiency of the UV light source 65 as discussed above, makes the use of batteries as the power source 77 more practical. Batteries may be used that are small and have a long life cycle.

Although the filtering unit 61 is described above as including solid walls, the walls may alternatively include openings therein, or a non-wall support structure may be provided for the filtering unit 61. In this case, a reflective coating or surface may be provided on portions of the receptacle 57 that would be exposed during a disinfection operations as well as on exposed portions of the filtering unit 61.

In some applications, only filtration of the fluid, and not disinfection of the fluid, may be desired. For these applications, the bottle 55 may be provided without the means for disinfecting the fluid in the bottle. This configuration of the bottle provides significant benefits for these applications. The bottle configuration would be the same, but without the UV light source 65 and housing 75, and reflective surfaces or coatings. Depending on whether electrical functions are provided in the bottle 55, circuitry 79 and power source 77 may also be eliminated. The overall size of the bottle may therefore be smaller, with more flexibility is afforded for the top opening. Further, more fluid may be introduced within the bottle because no volume is occupied by a light source and associated housing. The receptacle 57 may also be transparent, such that the amount of fluid 59 in the bottle may be viewable through openings in the filtering unit 61. Further, the receptacle 57 may be marked with gradations to show the amount of fluid in the bottle, and may include a maximum fill line.

The foregoing is just one example of a configuration for container that may be used to filter and/or disinfect fluid. It should be appreciated that although the container of FIGS. 6A-6D is described as a “bottle,” the invention is not limited to a container of the configuration shown. Rather, the bottle may be any portable container used to hold fluid.

Pitcher for Treating Fluids

Another configuration of a fluid dispenser that may perform filtering and disinfection functions is a pitcher. A pitcher with a built-in water filter is already popular for removing particulates and/or chemicals from drinking water. Applicant has appreciated that such a pitcher may be modified to allow disinfection of fluids with UV light. Optionally, the pitcher may be modified to include high efficiency UV light disinfection capabilities, as discussed herein.

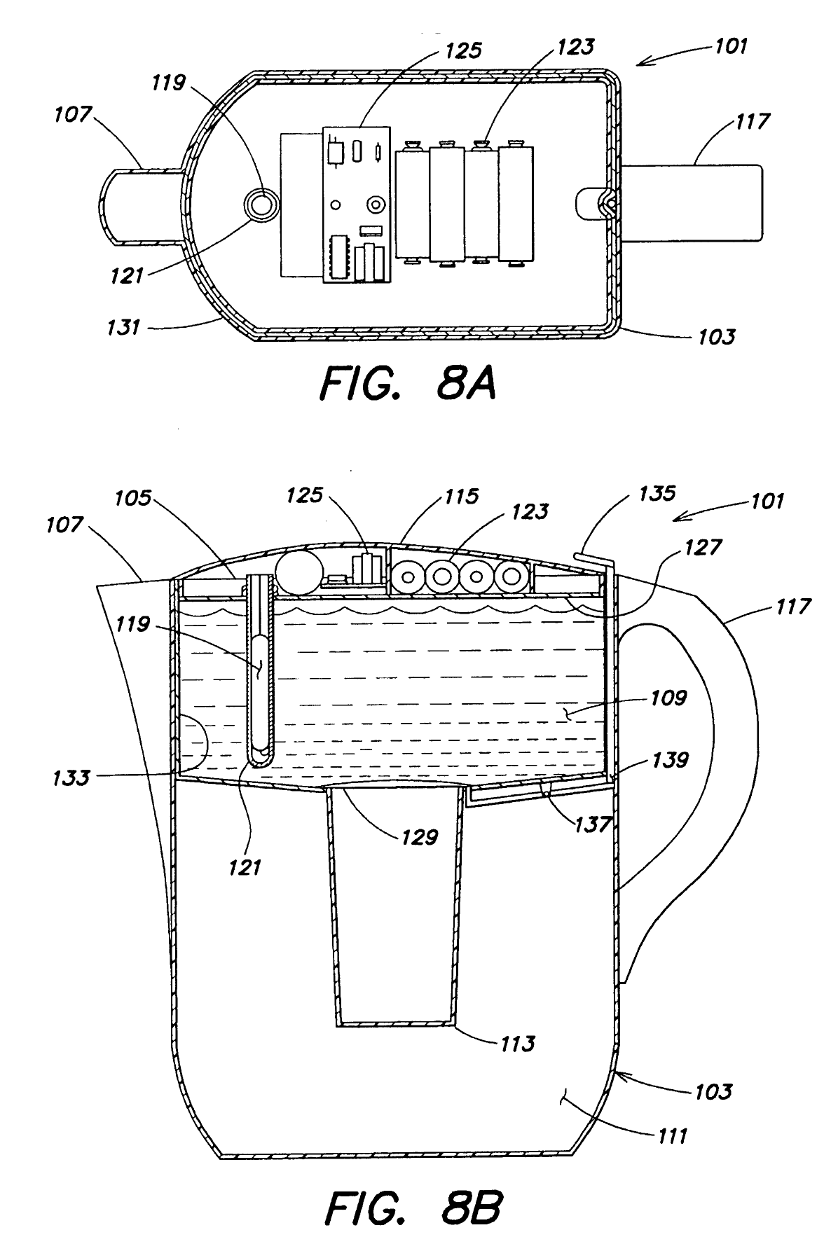

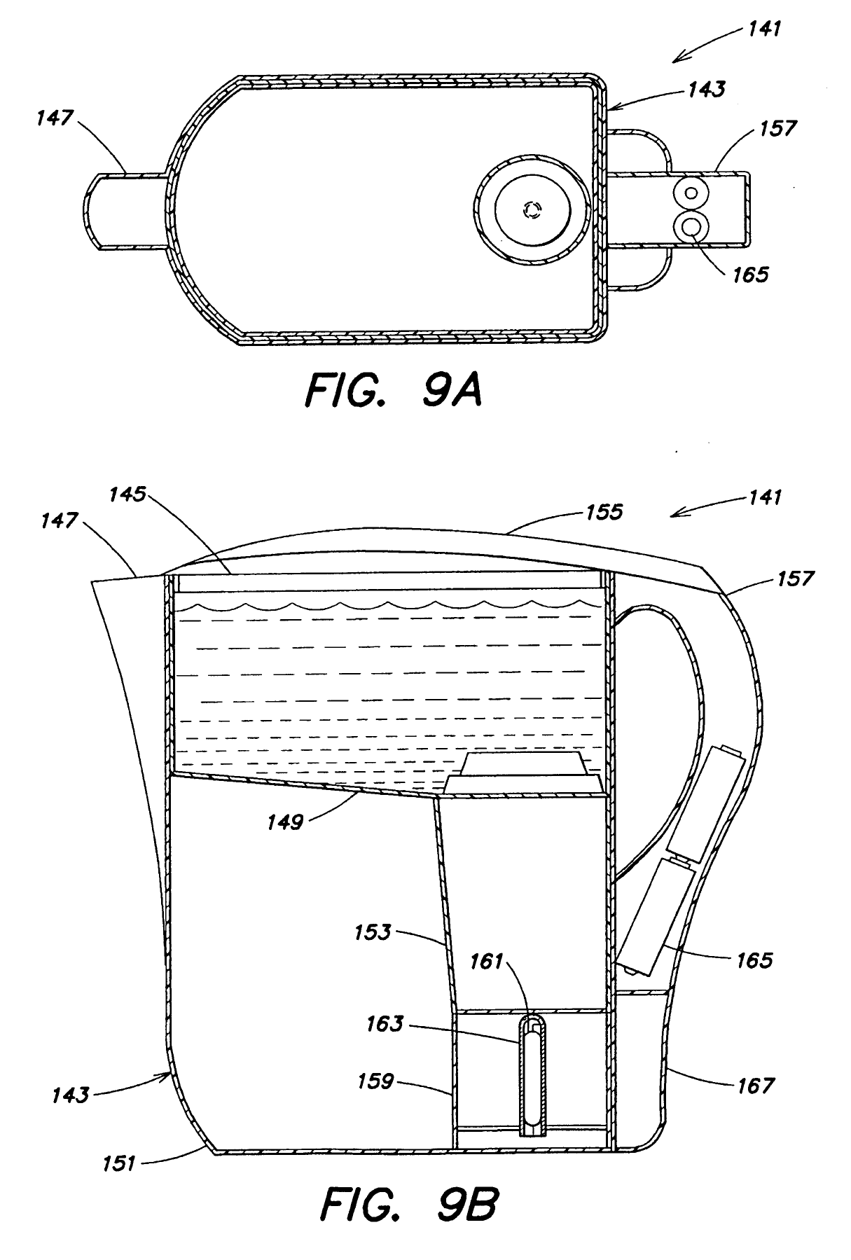

One illustrative embodiment of a pitcher 101 for filtering and disinfecting water or other fluids is shown in FIGS. 8A-8B, which show top and side views, respectively, of the interior of the pitcher. The pitcher 101 comprises a receptacle 103 to hold fluid, a top opening 105 for receiving fluid, and a spout opening 107 for dispensing fluid. Further, the receptacle comprises an upper reservoir 109 for initially receiving fluid from the top opening 105, and a lower reservoir 111, which receives fluid from the upper reservoir 109 after passing through a filtering unit 113. A cover 115 is provided that fits within the top opening 105 for covering the opening. A handle 117 is coupled to the receptacle 103 for convenient handling of the receptacle.

The pitcher 101 further comprises means for disinfecting the fluid in the pitcher. Specifically, a UV light source 119 is electrically coupled to the cover 115 for illuminating the fluid with UV light. According to the exemplary implementation shown, the UV light source 119 is a cylindrical lamp coupled to the cover 115 such that the UV light source 119 extends into the first reservoir 109 when the cover 115 is placed in the top opening 105 of the receptacle 103. A UV-transmissive housing 121 is provided to enclose the UV light source 119, such that the UV light source 119 does not come into direct physical contact with the fluid. According to one exemplary implementation, the UV light source 119 is a cylindrical xenon flash lamp, although other shapes and types of the UV light source may alternatively be used.

A power source 123 is provided within the cover 115 to power the UV light source 119. In the example shown, the power source 123 comprises batteries that are fully enclosed within a portion of the cover 115. In addition, circuitry 125 is provided within the cover 115 to drive the UV light source 119. Exemplary circuitry that may be used with a xenon flash lamp was described in connection with FIG. 7. The cover 115 may be constructed to provide a fluid-tight environment for the power source 123 and the circuitry 125.

The inner walls of the upper reservoir 109, the lower surface 127 of the cover 115, and the upper surface of valve 129 (discussed below), are constructed of or coated with a material 133 reflective to UV light. As shown in FIG. 8A, the wall of the upper reservoir adjacent the spout forms a parabolic reflector 131, and the UV light source 119 is oriented along the focus of the parabolic reflector when positioned in the upper reservoir. Thus, upper reservoir 109 is shaped and constructed to produce regenerative heating of the UV light source 119 in the same manner as discussed in connection with the embodiment of FIG. 4. The reflective material 133 in the upper reservoir 109 may serve a function of preventing UV light from passing through the walls of the receptacle 103, thereby preventing accidental exposure of a user to UV light during the disinfection operation.

Disinfection may be initiated manually or automatically. For example, disinfection may be initiated automatically by a mechanical switch that is initiated by placing the cover 115 in the top opening. In addition to, or as an alternative to the mechanical switch, disinfection may be initiated automatically by a light detector that detects a level of light in the upper reservoir 109. If the light detector detects that the light in the upper reservoir 109 is less that a determined level, disinfection may be initiated. Alternatively, disinfection may be initiated manually by a user activating a start switch. A lockout may be provided in this instance to prevent the user from initiating disinfection when the cover 115 is not secured within the top opening 105. For example, a lockout may be responsive to a light sensor or a mechanical switch such as those described above, which may provide an indication of whether the pitcher 101 is open.

Disinfection may also be stopped manually (e.g., by a user activating a switch) or automatically. The light detector described above may be used, for example, to detect whether a dosage of UV light sufficient for disinfection of the fluid has been applied. When the light detector indicates that a sufficient dosage has been applied, disinfection may be terminated by deactivating the UV light source 119. The features described above for initiating and terminating disinfection may be used in connection with any of the other embodiments described herein that relate to disinfection.

After disinfection, the fluid is released from the upper reservoir to flow through the filter to the lower reservoir for use. According to one exemplary implementation, a valve 129 is used to control this release, and is manually triggered by actuation of a button 135. The button 135 is coupled to the valve 129 via a triggering arm 139, which pivots about a pivot point 137. When the button 135 is depressed, the side of the triggering arm 139 on the button side of the pivot point 137 is pushed down, such that the side of the triggering arm 139 on the valve side is pushed up. This upward motion of the triggering arm 139 pushes the valve 129 upward, releasing the fluid in the upper reservoir 109. The valve 129 may be made buoyant so that it floats open once it is triggered and remains open until the fluid drains from the first reservoir 109. The opening of the valve 129 may alternatively be triggered automatically by an actuator controlled by the disinfection driving circuitry 125, which may provide an indication of when disinfection is complete.

Another illustrative embodiment of a pitcher 141 for filtering and disinfecting water or other fluids is shown in FIGS. 9A-9B, which show top and side views, respectively, of the interior of the pitcher. In contrast with the embodiment of FIGS. 8A-8B, the pitcher 141 operates by disinfecting fluid as it flows through the pitcher, rather than in a single batch.

The pitcher 141 comprises a receptacle 143 to hold fluid, a top opening 145 for receiving fluid, and a spout opening 147 for dispensing fluid. Further, the receptacle comprises an upper reservoir 149 for initially receiving fluid from the top opening 145, and a lower reservoir 151, which receives fluid from the upper reservoir 149 after passing through a filtering unit 153. A cover 155 is provided that fits within the top opening 145 for covering the opening. A handle 157 is coupled to the receptacle 143 for convenient handling of the receptacle.

The pitcher 141 further comprises means for disinfecting the fluid in the pitcher. A disinfection chamber 159 is provided along a path between the filtering unit 153 and the lower reservoir 151 to disinfect fluid that has passed through the filtering unit. A UV light source 161 is disposed within the disinfection chamber 159 for illuminating the fluid within the chamber with UV light. According to the exemplary implementation shown, the UV light source 161 is a cylindrical lamp enclosed within a fluid-impermeable housing 163 made from a UV transmissive material (e.g., quartz, fused silica, or UV transparent glass). According to one exemplary implementation, the UV light source 161 is a cylindrical xenon flash lamp, although other shapes and types of the UV light source may alternatively be used. For example, a continuous UV light source may alternatively be used to continuously illuminate the chamber while fluid is contained therein or passes therethrough.

A power source 165 is provided within the handle 157 to power the UV light source 161. In the example shown, the power source 165 comprises batteries that are fully enclosed within a portion of the handle 157. In addition, circuitry is provided within a circuitry compartment 167 of the handle 157 to drive the UV light source 161. Exemplary circuitry that may be used with a xenon flash lamp was described in connection with FIG. 7. The handle 157 may be constructed to provide a fluid-tight environment for the power source 161 and the circuitry. It should be appreciated that the location of the power source 161 and circuitry shown in FIG. 8B is merely exemplary, as many locations are possible. For example, the power source 161 and the circuitry could alternatively be provided in the cover or in a compartment in the base of the receptacle 143. Further, the pitcher 141 may include provisions for receiving power from an external power source, such as a low voltage converter plug for power from the AC line.

According to one exemplary implementation, the disinfection chamber 159 may be constructed in the manner described in connection with the improved-efficiency UV disinfection apparatus shown in FIG. 3. Thus, the disinfection chamber 159 may be cylindrical and have UV reflective walls to promote regenerative heating of the UV light source 161. The reflective walls of the disinfection chamber 159 may also serve a function of preventing UV light from passing through the walls of the receptacle 143, thereby preventing accidental exposure of a user to UV light during the disinfection operation.

Disinfection may be initiated manually or automatically. For example, disinfection may be initiated automatically by a fluid detector that triggers operation of the UV light source 161 in response to an indication of fluid flowing through or being present in the disinfection chamber 159. The UV light source 161 may be turned-on or flashed repeatedly to expose the fluid in the disinfection chamber 159 to sufficient germicidal UV light for the desired level of disinfection. In addition to, or as an alternative to the fluid detector, disinfection may be initiated manually by a user activating a start switch.

A shut-off valve may be provided to stop the flow of fluid into the lower reservoir 151 upon detection of an insufficient amount of light production by the UV light source 161. The shut-off valve would automatically prevent contaminated fluid from flowing into the lower reservoir 151. The valve may be provided at the entrance to the disinfection chamber 159 or the exit to the disinfection chamber, for example, and may be coupled to a light detector in the chamber. In addition, a visual indicator (e.g., a light) or other indicator may be provided to the user to indicate the failure condition of the UV light source 161. Such an indicator may be provided with any of the other embodiments described herein.

Fluid may be released continuously from the disinfection chamber 159 through one or more openings therein to the lower reservoir 151. Alternatively, fluid may be released intermittently from the disinfection chamber 159 via one or more valves associated therewith to the lower reservoir 151.

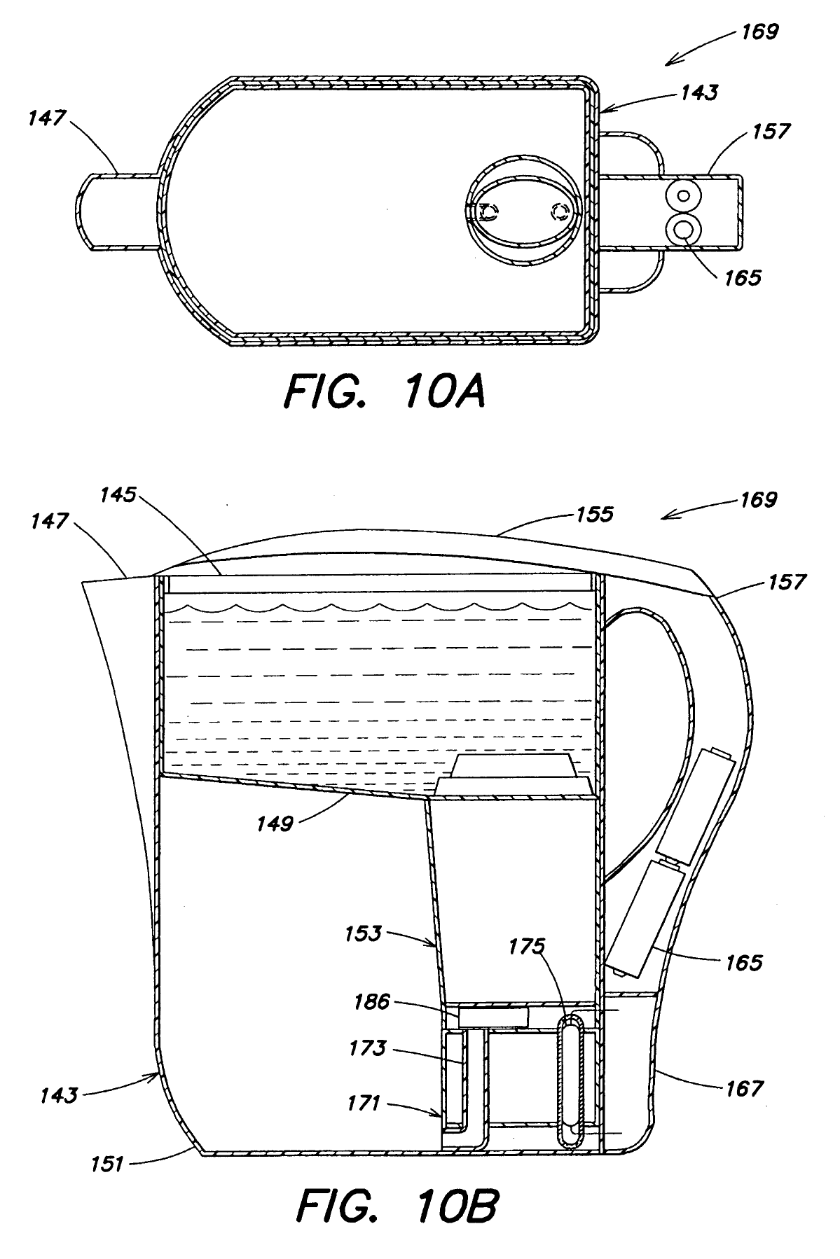

A further illustrative embodiment of a pitcher 169 for filtering and disinfecting water or other fluids is shown in FIGS. 10A-10B, which show top and side views, respectively, of the interior of the pitcher. The embodiment of FIG. 10 differs from the embodiment of FIG. 9 only in the construction of the disinfection chamber, described below.

The disinfection chamber 171 of this embodiment is constructed in the manner described in connection with the improved-efficiency UV disinfection apparatus shown in FIGS. 5A and 5B. Thus, the disinfection chamber 171 is ellipsoidal, and has flow tube 173 along one focus of the ellipse and a UV light source 175 along the other focus of the ellipse when the chamber is viewed in cross-section. The disinfection chamber 171 also includes UV reflective walls to direct UV light towards the flow tube 173 to disinfect the fluid therein, and to the UV light source 175 to promote regenerative heating of the light source as described in connection with the embodiment of FIGS. 5A and 5B.

Fluid flows through the flow tube 173 when passing through the disinfection chamber 171 between the filtering unit 153 and the lower reservoir 151. A sensor 177 may be provided to detect when to operate the UV light source 175. In this configuration, the UV lamp may be operated continuously, or flashed at rate rapid enough so that all the fluid passing through the flow tube 173 is exposed to a sufficient amount of UV light. The sensor 177 may be responsive to fluid pressure or flow. A valve may also be coupled to the sensor 177 to release the fluid from the filtering unit 153 into the flow tube 173 when a sufficient amount of fluid ready for disinfection has been sensed. Other features described in connection with the embodiment of FIGS. 9A-9B (e.g., the light sensor and shut-off valve) may be incorporated in the pitcher 169 of the present embodiment as well.

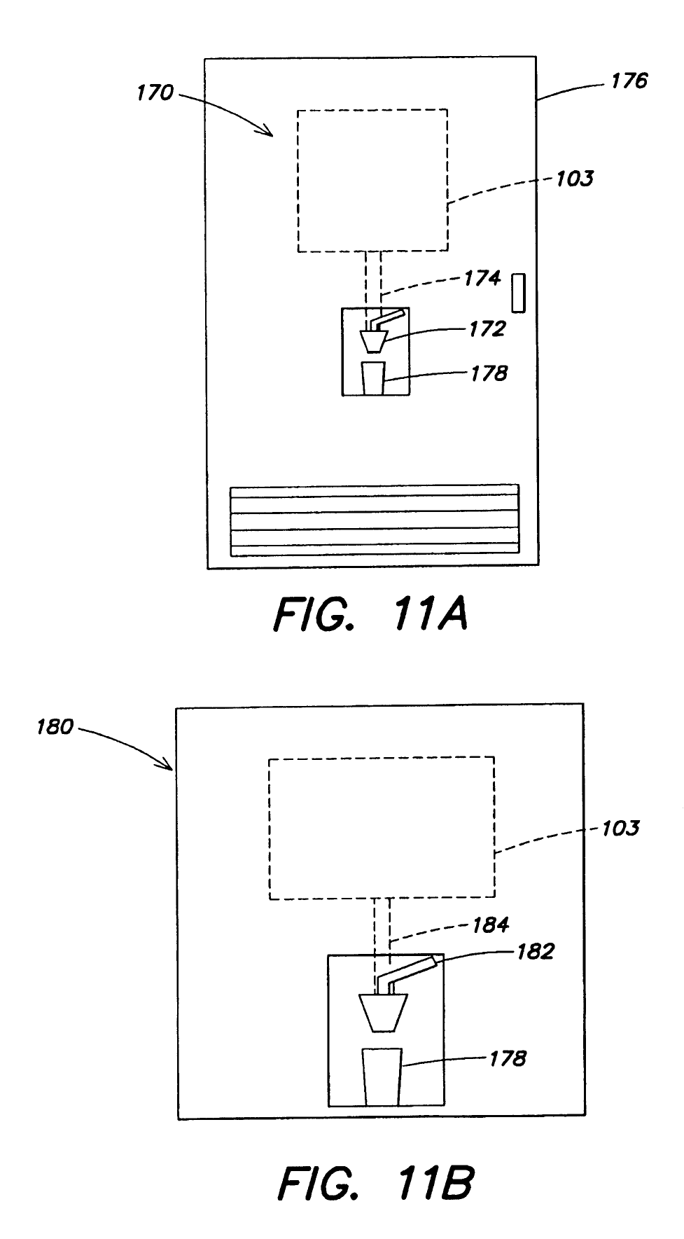

The embodiments described in connection with FIGS. 8-10 are just a few exemplary configurations of a pitcher-style fluid filtration and disinfection system. It should be appreciated that other configurations and applications for the configurations described are possible. FIGS. 11A and 11B show illustrative embodiments of other possible applications of the receptacle 103 shown in FIGS. 8A-8B. FIG. 11A shows a refrigerator-mountable unit 170 for dispensing filtered and sterilized fluid (e.g., water). The unit 103 includes the receptacle 103 of FIG. 8 and a valved outlet port 172 coupled to the receptacle via a tube 174. The tube 174 may be coupled to an opening in the lower reservoir 111 (FIG. 8) of the receptacle 103. The valved outlet port 172 may be included, e.g., on the door of a refrigerator 176 to dispense fluid into a cup 178 or the like. FIG. 11B shows a water cooler unit 180 for dispensing filtered and sterilized fluid (e.g., water). The unit 180 includes the receptacle 103 of FIG. 8 and a valved outlet port 182 coupled to the receptacle via a tube 184. The tube 184 may be coupled to an opening in the lower reservoir 111 (FIG. 8) of the receptacle 103. The valved outlet port 182 may be included, e.g., on the front face of the water cooler unit 180 to dispense fluid into a cup 178 or the like.

Faucet-Mountable Device for Treating Fluids

Another configuration of a fluid dispenser that may perform filtering and disinfection functions is a faucet-mountable device. A faucet-mountable device for water filtration is popular for removing particulates and/or chemicals from drinking water. Applicant has appreciated that such a faucet-mountable device can be modified to include disinfection of the water with UV light. Optionally, the device may further be modified to include high efficiency UV light disinfection capability, as discussed herein.

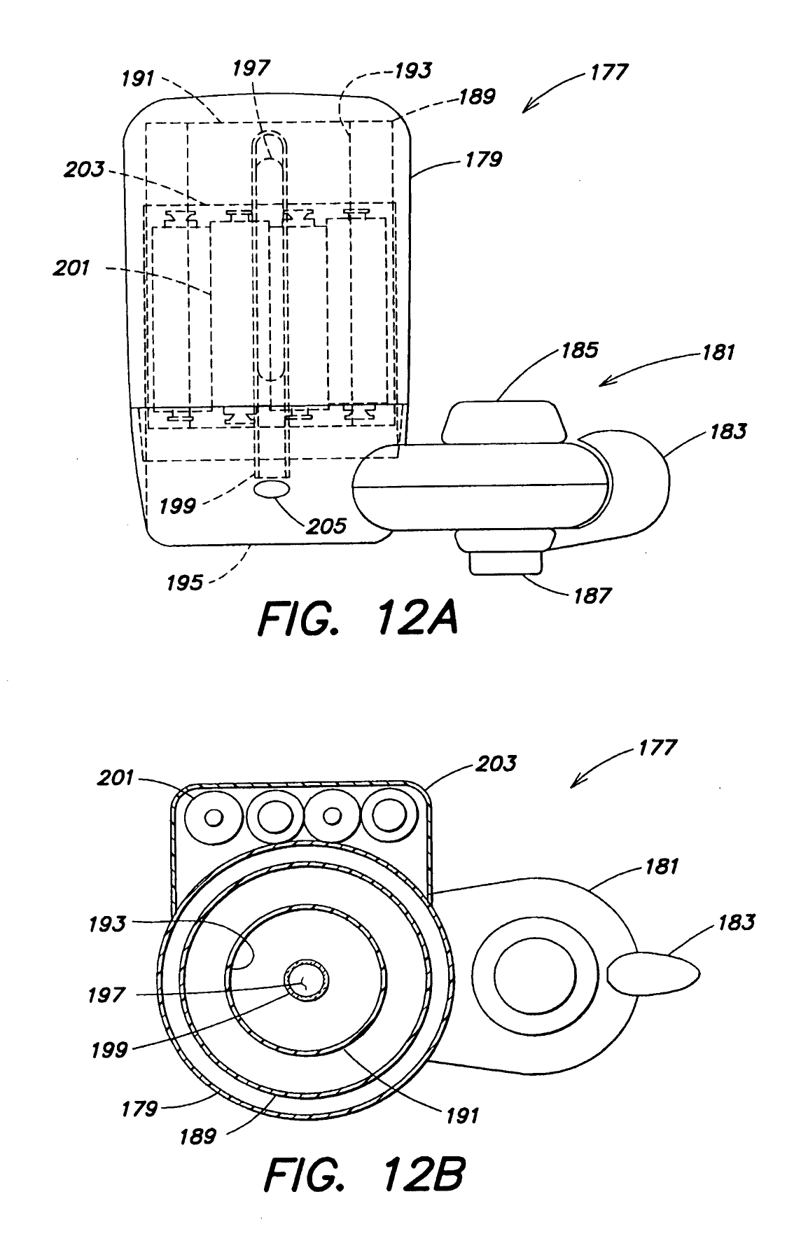

One illustrative embodiment of a faucet-mountable device 177 for filtering and disinfecting water or other fluids is shown in FIGS. 12A-12B, which show front and top views, respectively, of the interior of the device. The device comprises a housing 179, wherein filtering and disinfection of fluid occurs, and an attachment unit 181 for attaching the housing to a faucet. The attachment unit 181 may be attached to the bottom of a faucet via a screw mechanism or other attachment mechanism. A control lever 183 is coupled to the attachment unit 181 to control the flow of fluid through the attachment unit. In a first position, the control lever 183 causes the fluid to flow from an entrance port 185 of the attachment unit 181 to an outlet port 187 of the attachment unit without passing through the housing 179. In a second position, the control lever 183 causes the fluid to flow from the entrance port 185 of the attachment unit 181 into the housing 179.

Within the housing, fluid is first channeled upward through a cylindrical filter 189. The filter 189 is constructed to filter the fluid of particulates and/or chemicals. After passing through the filter 189, the fluid is channeled downward through a cylindrical disinfection chamber 191 disposed within the cylindrical filter 189. The filter 189 may be separated from the disinfection chamber by outer walls 193 of the disinfection chamber, as shown. Within the disinfection chamber, the fluid is disinfected using germicidal UV light. Finally, the fluid is released from the housing 179 via an outlet port 195 in the housing 179. It should be appreciated however, that the housing 179 may be modified such that fluid flows upward through the disinfection chamber 191 first, then downward through the filter 189 before being released from the outlet port 195 in the housing 179.

According to one exemplary implementation shown, the disinfection chamber 191 may be constructed in the manner described in connection with the improved-efficiency UV disinfection apparatus shown in FIG. 3. Thus, the disinfection chamber 191 may be cylindrical and have UV reflective walls 193 to promote regenerative heating of a cylindrical UV light source 197. The reflective walls of the disinfection chamber 191 may comprise a coating on the inside of the filter, according to one exemplary implementation. The UV light source 197 may be disposed in a fluid-impermeable housing 199 longitudinally along the center of the disinfection chamber 191. According to one exemplary implementation, the UV light source 197 is a cylindrical xenon flash lamp, although other shapes and types of the UV light source may alternatively be used.

A power source 201 is provided within a compartment 203 of the housing 179 to power the UV light source 197. In the example shown, the power source 197 comprises batteries. In addition, circuitry is provided within the compartment 203 to drive the UV light source 197. Exemplary circuitry that may be used with a xenon flash lamp was described in connection with FIG. 7. The compartment 203 may be constructed to provide a fluid-tight environment for the power source 201 and the circuitry.

Disinfection may be initiated manually or automatically. For example, disinfection may be initiated manually by movement of the control lever 183. In addition to, or as an alternative to the control lever, disinfection may be initiated automatically by a fluid sensor that detects the presence or movement of fluid in the housing 179. A shut-off valve may be provided to stop the flow of fluid into the housing 179 upon detection of an insufficient amount of light production by the UV light source 197. The shut-off valve would automatically prevent contaminated fluid from flowing into the housing by diverting fluid to the outlet port 187 on the attachment unit 181. In addition, a visual indicator (e.g., a light) or other indicator may be provided to the user to indicate the failure condition of the UV light source 197.

The device 177 may also contain a mechanism to measure its usage to provide an indication 205 to the user when it is time to replace the filter 189. This mechanism could, for example, be a turbine that is turned by fluid flow through the housing 178. The turbine may be then geared down to move a pointer to indicate the usage. When replacement of the filter is needed, a replacement filter module, comprising the filter 189 and the reflective material disposed thereon 193, may be introduced into the housing in place of the used filter module.

It should be appreciated that while the device 177 described in connection with FIGS. 12A-12B is shown and described as being faucet mountable, the device may alternatively be connected to a faucet without being physically mounted thereon. For example, the housing 179 of FIG. 12 may be provided below a sink comprising the faucet, next to a sink comprising the faucet, or elsewhere in relation to a faucet. The attachment unit 181 may comprise flexible tubing for transporting fluid from the attachment unit to the housing 179. This modification of the attachment unit 181 would not change the operation of the housing 179, which would function in the manner described above.

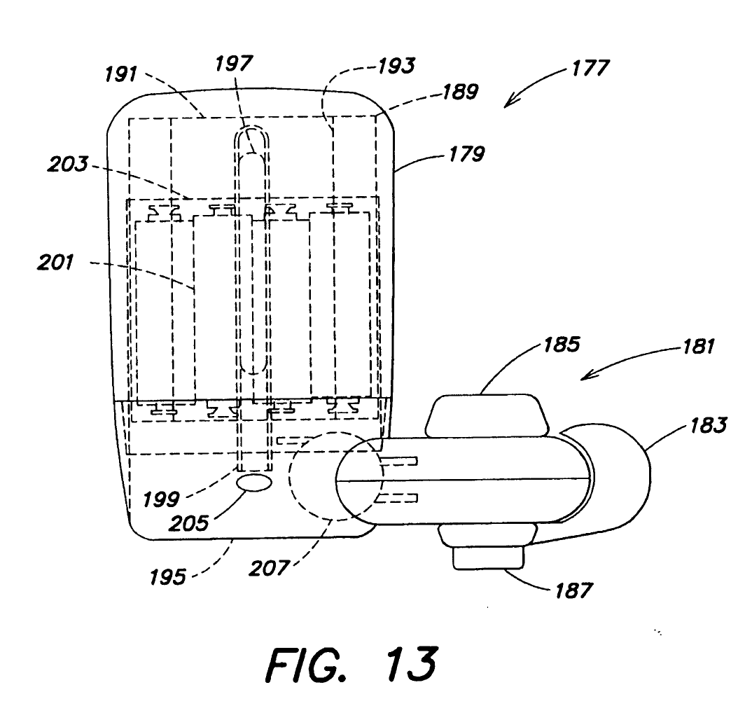

It is also possible to use a power source other than batteries to power the UV light source 197 or other electrical functions within the faucet-mountable device 177, such as the visual indicator of UV light source failure, described above. For example, a transducer could be included that converts mechanical energy generated by the flow of fluid through the device 177 to electrical energy that may serve as a power source. FIG. 13 shows an exemplary placement of a transducer 207 that may be used to harness energy from the movement of fluid through the attachment unit. The transducer 207 may comprise a turbine that turns in response to the movement of fluid through the attachment unit 181 and an electrical generator that generates electrical energy from the mechanical energy of the turbine. The transducer 207 could produce a voltage that is used to power, in place of or as a supplement to the batteries 201, a circuit similar that shown in FIG. 7. Alternatively, the transducer 207 could produce a higher voltage that could be used to directly charge the high voltage energy storage flash capacitor associated with the circuit of FIG. 7. Whenever the capacitor reaches the set trigger voltage, the UV light source 197 is flashed, and charging continues as long as there is fluid flow through the device 177. If more power is necessary than can be conveniently generated by the fluid that flows through the device 177, additional fluid could be used to generate power that is not passed through the device 177, but is passed out the normal faucet outlet or other outlet. This could provide ample energy for the disinfection of the fluid passing though the filter and eliminate the need for batteries or other electrical power for the unit.

Point of Consumption Device for Treating Fluids

It is also possible to disinfect water or other fluids at the point of consumption by the user. This technique is particularly useful for travelers in locations where the water is of unknown quality. It has been recently publicized that the water served aboard airliners is sometimes microbially contaminated. The embodiments described below can be used to disinfect and/or filter fluid as it is consumed.

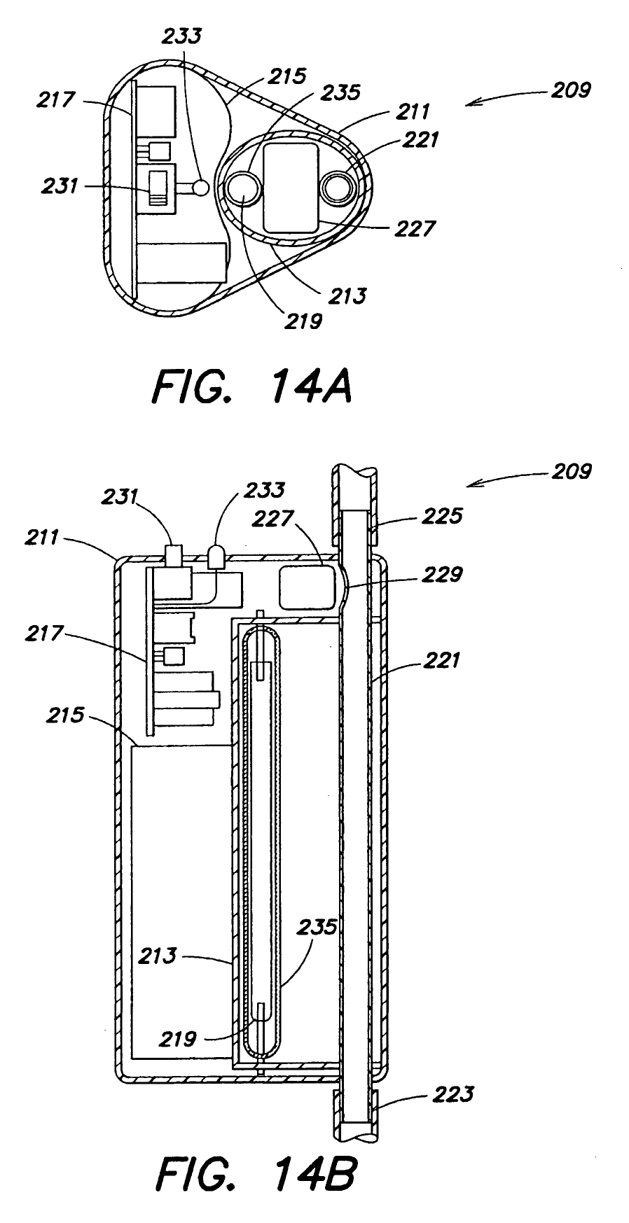

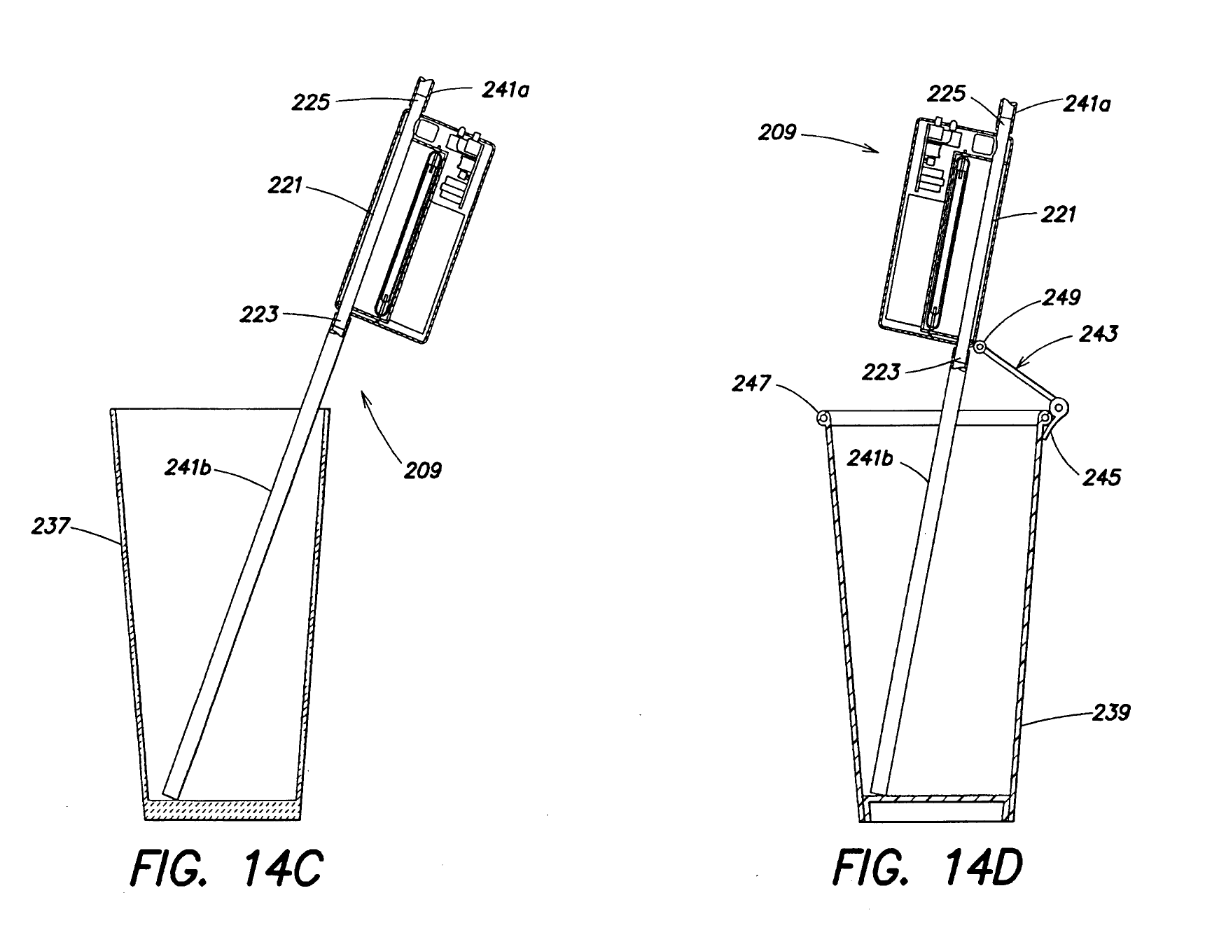

One illustrative embodiment of a straw-mountable device 209 for disinfecting water or other fluids is shown in FIGS. 14A-14D. The device comprises a housing 211 including a disinfection chamber 213, a power source 215, and circuitry 217 for driving a UV light source 219 housed within the disinfection chamber 213.

In the exemplary implementation shown, the disinfection chamber 213 of this embodiment is constructed in the manner described in connection with the improved-efficiency UV disinfection apparatus shown in FIGS. 5A and 5B. Thus, the disinfection chamber 213 is ellipsoidal, and has flow tube 221 at one focus of the ellipse and a UV light source 219 within a housing 235 at the other focus of the ellipse when the chamber is viewed in cross-section. The disinfection chamber 213 also includes UV reflective walls to direct UV light towards the flow tube 221 to disinfect the fluid therein, and to the UV light source 219 to promote regenerative heating of the light source as described in connection with the embodiment of FIGS. 5A and 5B.

Fluid flows through the flow tube 221 when passing through the disinfection chamber 213 between the first end 223 and the second end 225 of the flow tube. Disinfection may be initiated manually or automatically. For example, disinfection may be initiated manually by a user activating a start switch. Alternatively, disinfection may be initiated automatically using a sensor 227 to detect suction applied by the user to the straw, such that the UV light source 219 may be activated before the fluid flows through the disinfection chamber. One way to detect the suction is to include a flexible wall section 229 in the flow tube 221 that will bend or stretch inward when suction is applied. This distortion inward can be detected optically with a standard reflective or transmissive sensor. It could also be detected with a capacitive sensor where the capacitance between two plates changes depending on the distance between them and the tube wall. Many other sensor types could be used and are well known to those skilled in the art.

The UV lamp may be operated continuously, or flashed at rate rapid enough so all the fluid passing through the flow tube 221 is exposed to sufficient UV light. According to one exemplary implementation, the UV light source 219 is a cylindrical xenon flash lamp, although other shapes and types of the UV light source may alternatively be used.

A power source 215 is provided within the housing 211 to power the UV light source 219. In the example shown, the power source 215 comprises a battery source. However, other power sources are possible, such as a remote power source (e.g., an AC line). A power switch 231 and a power indicator 233 are provided on the exterior of the housing, as shown in FIG. 14B. In addition, circuitry 217 is provided within the housing 211 to drive the UV light source 219. Exemplary circuitry that may be used with a xenon flash lamp was described in connection with FIG. 7. The housing 211 may be constructed to provide a fluid-tight environment for the power source 215 and the circuitry 217.

FIGS. 14C-D illustrate the use of the straw-mountable device 209 to drink fluid from a glass 237 or cup 239. Straw extensions 241a, 241b may be coupled to the first and second ends 223, 225 of the flow tube 221 to provide a replaceable interface with the straw-mountable device 209. It should be appreciated, however, that the invention is not limited in this respect. For example, the flow tube 221 may instead be constructed with first and second ends 223, 225 that extend a greater distance from the straw-mountable device 209, such that straw extensions are unnecessary. Alternatively, a replaceable UV-transmissive straw may be introduced through the device prior to each use within or in the location of the flow tube. Thus, the straw may entirely traverse the straw-mountable device 209, eliminating the need for straw extensions.

When used with a heavy (e.g., glass) cup 237, as shown in FIG. 14C, the straw-mountable device 209 may be light and stable enough to be rested against the edge of the cup. However, when used with a lightweight (e.g., paper or plastic) cup 239, as shown in FIG. 14D, a stabilizer 243 may be used to hold the straw-mountable device 209. The stabilizer 243 comprises a clip 245 to clip the stabilizer to a rim 247 of the cup 239. In addition, the stabilizer 243 comprises a pivoting attachment mechanism 249 for pivotally attaching the stabilizer to the straw-mountable device 209. When not in use, the stabilizer 243 may be folded against the device 209.

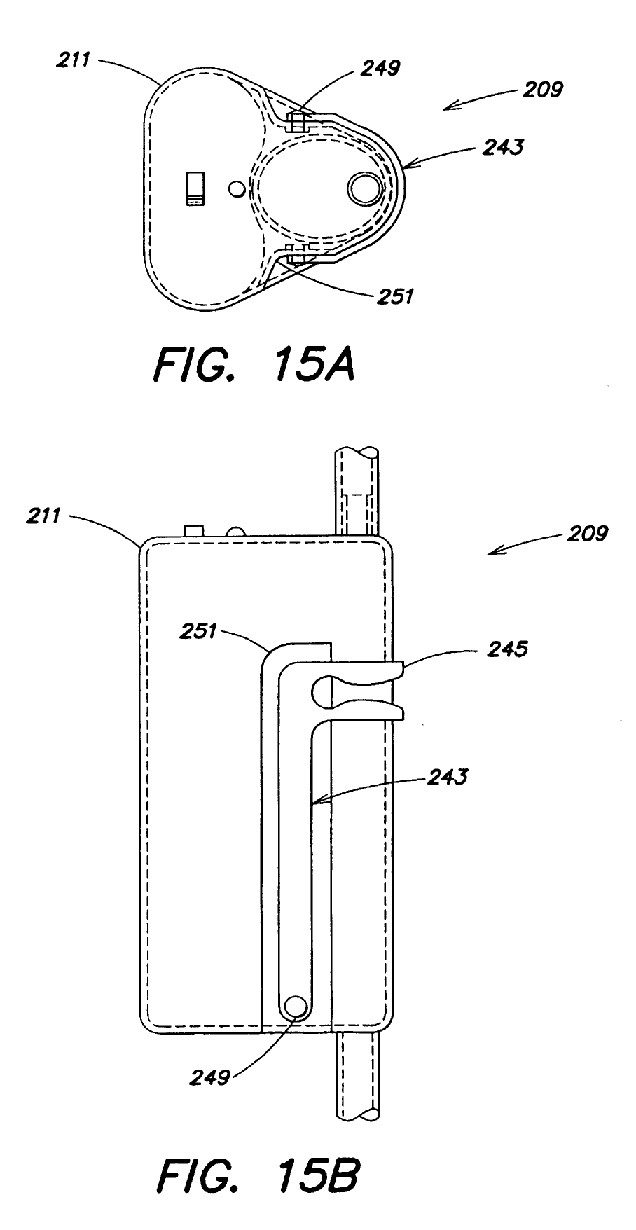

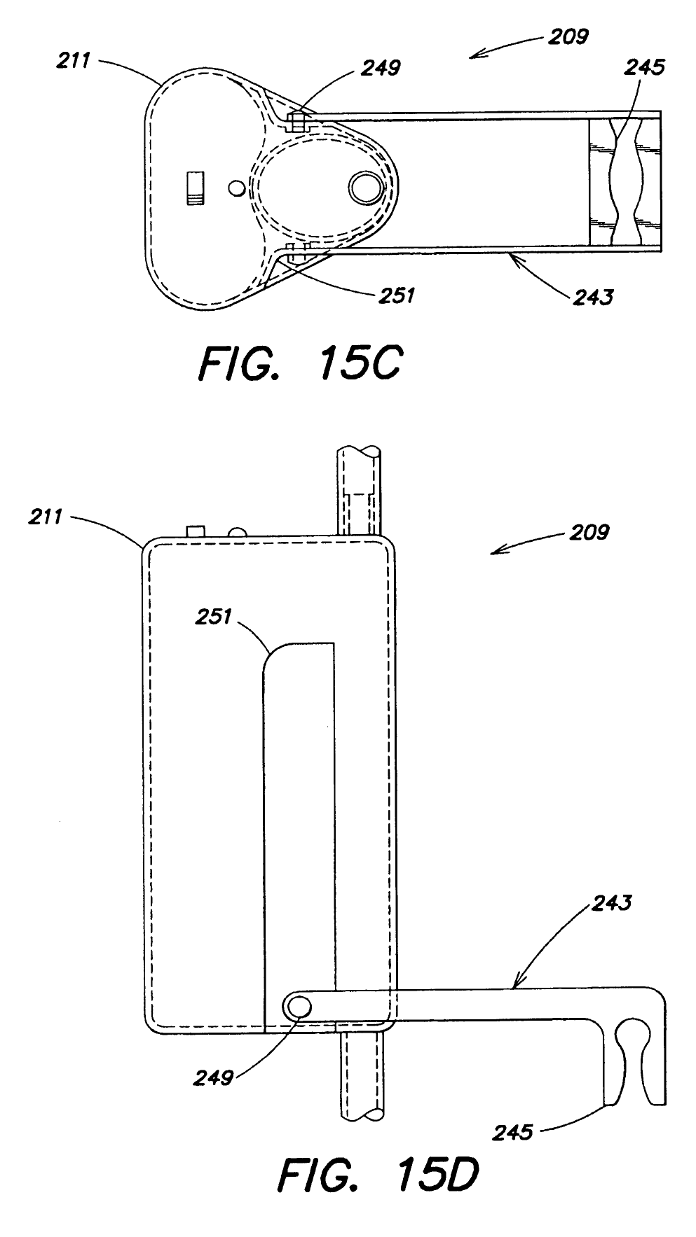

FIGS. 15A-15D illustrate how the stabilizer 243 of FIG. 14D may be folded against the straw-mountable device 209 when not in use. FIGS. 15A-15B illustrate the stabilizer 243 folded into a recess 251 in the housing 211, such that the stabilizer 243 is in a non-use position. FIGS. 15C-15D illustrate the stabilizer 243 in an extended position, such that it may be clipped onto the rim of a cup. The pivoting attachment mechanism 249 allows the stabilizer 243 to engage rims of different sizes and heights. In addition, the clip 245 may be constructed of a flexible and resilient material to allow the clip the engage a variety of rim sizes.

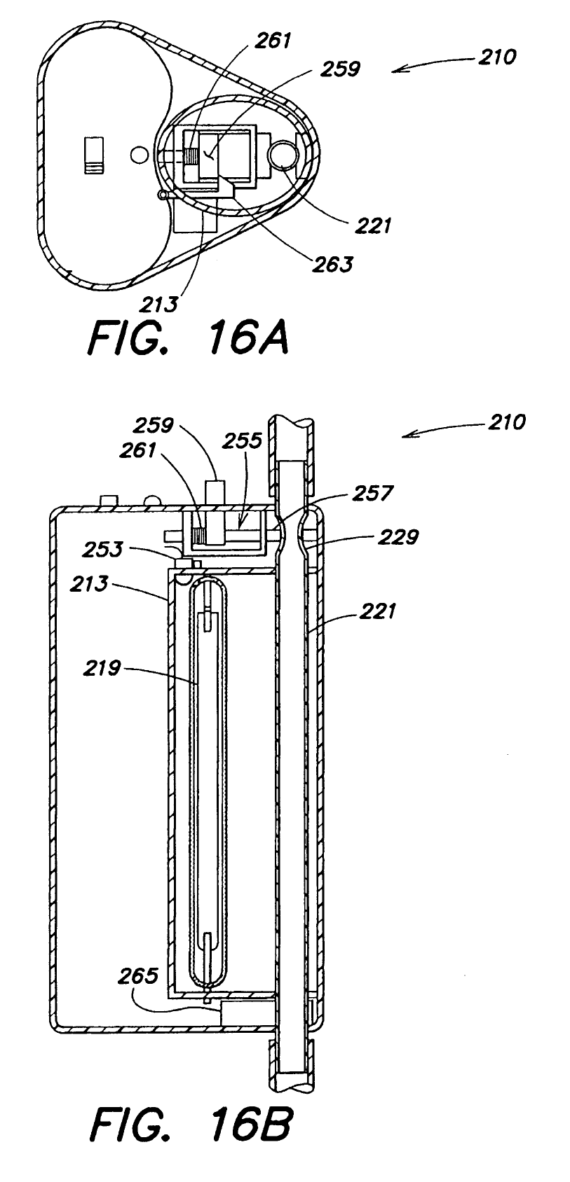

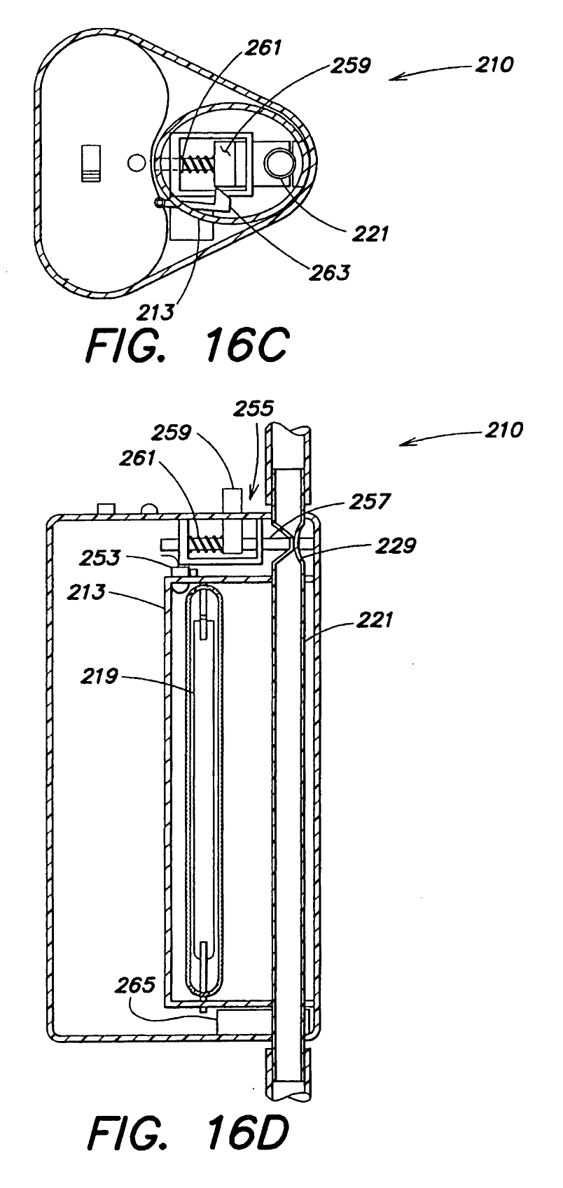

FIGS. 16A-16D illustrate a safety shut-off mechanism may be provided in a straw-mountable device 210 to stop the flow of fluid through the straw if the UV light source 219 is not generating a sufficient amount of light (e.g., due to damage, age, or low batteries) for proper disinfection. The straw-mountable device 210 is substantially the same as the device 209 described previously, other than the provision of the shut-off mechanism. FIGS. 16A-B show the shut-off mechanism in an open position, while FIGS. 16C-D show the shut-off mechanism in a closed position. In the exemplary configuration shown, a light sensor 253 is positioned to detect the light from the UV light source 219. The light sensor 253 does not necessarily have to sense germicidal UV light, as most UV light sources produce visible light in a known ratio to UV light. Thus, the visible light can be sensed with a standard visible light sensor to determine the operation of the UV light source. The light sensor 253 can sense the light at any point in the disinfection chamber 213 and the sensed value will be proportional to the UV light applied to the fluid. The threshold value for the light sensor 253 may be set to indicate when the UV light level has fallen to the lowest value, with a safety margin, that provides adequate disinfection.

When the level detected by the light sensor has fallen below the threshold level, the circuitry 217 in the straw-mountable device 210 triggers a shut-off valve 255 to stop the flow of fluid through the flow tube 221. In the exemplary implementation of FIG. 16, the shut-off valve 255 is small, fast-acting, and low-power. Specifically, the shut-off valve 255 comprises a spring-loaded armature 257 that can pinch a flexible portion of the flow tube 221 to stop the fluid flow. To open the shut-off valve 255, a user pushes the external lever 259 attached to the armature 257 to move the armature against the spring 261 to a position where a spring loaded latch 263 catches the armature 257 to hold the valve open. The armature 257 can be coupled to the power source to apply power to the circuitry when the shut-off valve 255 is open. The shut-off valve 255 can be closed with an electric current applied to a solenoid that releases the latch 263 that holds the armature 257 in place against the spring force. When the latch 263 is released, the shut-off valve 255 closes very rapidly due to the spring force. An advantage of this type of shut-off valve is that the primary energy to drive the valve is supplied by the user cocking the spring 261. This energy can move the shut-off valve 255 very rapidly. Because the device 210 does not have to supply the energy to move the armature 257, but only enough energy to release the latch 263, very little energy is required, and a very small solenoid can be used.

The exemplary implementation of the shut-off valve 255 described above involves actuation of the power switch by the armature 257 when the valve is opened by the user. This assures that the device is turned-on whenever the shut-off valve 255 is open, so the user cannot accidentally use the straw-mountable device 210 with the power turned-off. The latch 263 on the armature 257 could be designed so the user can supply external force to release the latch to close the valve 255 and turn the device 210 off. Alternatively, the device 210 could be turned-off with a separate external button or lever connected to the latch 263 to release it, or a switch could be provided to direct an electrical signal to the solenoid to release it. This configuration could also include a timer to detect a significant period (e.g., 10 minutes) of non-use, and turn the device 210 off automatically to conserve the power source. The user could reset the valve 255 to restart the device 210, and the valve would prevent use until the device was turned-on.

As described in connection with FIGS. 14A-B, disinfection may be initiated automatically using a sensor 227 to detect suction applied by the user to the straw, such that the UV light source 219 may be activated before the fluid flows through the disinfection chamber. According to another exemplary implementation, a fluid detector 265 may be employed to determine if any fluid is present at the lower end of the disinfection chamber 213. When fluid is detected, the UV light source 219 is turned-on. In connection with the shut-off valve 255, this automatic initiation of the UV light source 219 and automatic closure of the flow tube 221 in the event of partial or total failure or the UV light source prevents any untreated fluid from reaching the user. If the UV light source 219 is working properly, the shut-off valve 255 remains open, and the fluid flowing through the disinfection chamber 213 is allowed to flow to the user.

Another feature that may be included in the straw-mountable device 21 0 is a 5 mechanism to ensure that the fluid flow rate does not exceed a level that assures proper disinfection. The flexible section 229 of the flow tube 221 can be made from an elastomeric substance and in an appropriate thickness, such that it will collapse if the user applies too much suction to the straw. The material, size and length of the flexible section 229 and the fluid drag or restriction to fluid flow can be chosen to restrict the maximum flow to a safe level depending on the UV light energy applied to the fluid.

FIGS. 14-16 show a variety of safety and control functions implemented in the straw-mountable device. It should be appreciated that these functions can be added in a similar fashion to any of the fluid disinfecting configurations described herein. For example, although the shut-off valve 255 has been discussed only in connection with the straw-mountable device 210, it should be appreciated that the shut-off valve may be used in connection with other disinfection devices disclosed herein the prevent fluid from being dispensed from the disinfection device in the event of partial or total failure of the associated UV light source.

In addition, features of the other embodiments described herein may be included in the straw-mountable device of FIGS. 14-16. For example, a filter such as those described in connection with other embodiments may be incorporated in the straw mountable device to provide both disinfection and filtering functions.

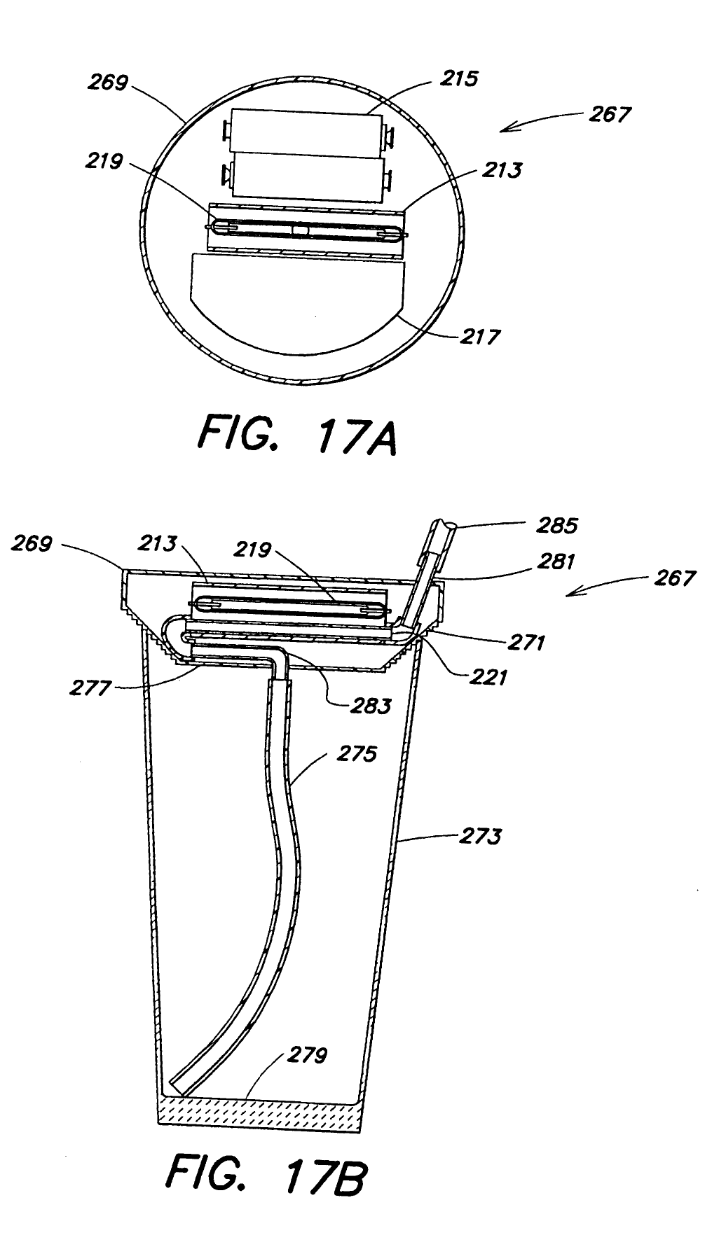

Another illustrative embodiment of a straw-mountable device 267 for disinfecting water or other fluids is shown in FIGS. 17A-17B. This embodiment involves an alternative mechanical configuration for the straw-mountable device. Specifically, straw-mountable device 267 is designed to sit stably on top of cups of a wide range in diameters. The disinfection chamber 213, power source 215, and circuitry 217 inside the device 267 are similar to that of the previously described straw-mountable devices 209 and 210, and may include any of the optional controls and safety mechanisms described. 30 The housing 269 of the straw-mountable device 267 is round, with sides 271 that taper in steps so that the device can rest on the rim of cups or containers of a variety of different diameters. The cup 273 supports the weight of the device 267, which is held over the center of the cup or glass to reduce its tendency to tip. In this device 267, the distance from the bottom surface 277 of the device to the bottom 279 of the cup is determined by how the module sits on the cup, and not the length of the intake straw 275. To assure that the straw 275 reaches the bottom of the glass, a long flexible intake straw is used so it can bend to compensate for different cup heights. The intake straw 275 may be press-fit onto flow tube portion 283, so that it can be easily replaced and different lengths can be used. Similarly, an output straw 285 may be press-fit onto flow tube portion 281 so that it may be replaced.

Having described several embodiments of the invention in detail, various modifications and improvements will readily occur to those skilled in the art. For example, a variety of different configurations, light sources types, drive circuits may be used. In addition, other applications are possible for the filtering and/or disinfection concepts and the regenerative heating techniques described herein. Further, the various controls, sensors, safety shut-off mechanisms, indicators, etc. described herein may be used in any combination in connection with any of the disclosed configurations. Such modifications and improvements are intended to be within the spirit and scope of the invention. Accordingly, the foregoing description is by way of example only, and is not intended as limiting. The invention is limited only as defined by the following claims and equivalents thereto.

What is claimed is:

1. A method of providing treated fluid, comprising acts of:
receiving the fluid into a chamber;
filtering the fluid of at least some particulate matter and/or chemicals within the chamber;
disinfecting the fluid with an ultraviolet light source within the chamber; and
dispensing the fluid from the chamber.

2. The method of claim 1, wherein the chamber comprises a pitcher.

3. The method of claim 1, wherein the chamber comprises a faucet-mountable treatment device.

4. The method of claim 1, wherein the chamber comprises a water bottle.

5. The method of claim 1, wherein the chamber comprises a straw.

6. The method of claim l, wherein the chamber comprises a water cooler.

7. The method of claim 1, wherein the chamber comprises a refrigerator-mountable treatment device.

8. The method of claim 1, wherein the act of filtering comprises filtering the fluid with a mechanical filter.

9. The method of claim 1, wherein the act of disinfecting comprises irradiating a continuous flow of the fluid with the ultraviolet light source.

10. The method of claim 1, wherein the act of disinfecting comprises irradiating a stationary quantity of the fluid with the ultraviolet light source.

11. The method of claim 10, further comprising an act of retaining the stationary quantity of the fluid with one or more valves.

12. A faucet-coupleable device for treating fluid, comprising:
a housing adapted to be coupled to a faucet such that the housing may receive fluid from the faucet;
a filter disposed within the housing to filter the fluid of at least some particulate matter and/or chemicals;
an ultraviolet light source disposed within the housing to disinfect the fluid; and
an outlet port to release the fluid.

13. The faucet-coupleable device of claim 12, wherein the housing is adapted to be mounted to a faucet.

14. The faucet-coupleable device of claim 12, further comprising:
means for activating the ultraviolet light source in response to an indication of fluid in the housing.

15. The faucet-coupleable device of claim 12, further comprising:
means for activating the ultraviolet light source in response to an indication of fluid flowing in the housing.

16. The faucet-coupleable device of claim 14, wherein the means for activating comprises a pressure sensor for providing the indication of fluid in the housing.

17. The faucet-coupleable device of claim 16, wherein the means for activating further comprises an electrical switch coupled to the ultraviolet light source and responsive to the indication.

18. The faucet-coupleable device of claim 12, further comprising a transducer that converts mechanical energy generated by movement of fluid within the housing to electrical energy.

19. The faucet-coupleable device of claim 18, wherein the transducer is electrically coupled to the ultraviolet light source.

20. The faucet-coupleable device of claim 12, further comprising:
a sensor to detect whether the ultraviolet light source is producing at least a predetermined light output; and
a valve to prevent the flow of fluid through the housing in response to an indication from the sensor that the ultraviolet light source is producing less than the predetermined light output.

21. A fluid dispenser, comprising:
a receptacle to hold fluid, the receptacle having a first opening for receiving fluid and a second opening for dispensing fluid;
a passage between the first opening and the second opening for allowing the passage of fluid between the first opening and the second opening;
a filter configured and arranged to filter the fluid of at least some particulate matter and/or chemicals as the fluid passes through the passage; and
an ultraviolet light source configured and arranged to disinfect the fluid in at least a portion of the receptacle.

22. The fluid dispenser of claim 21, wherein the receptacle comprises a pitcher.

23. The fluid dispenser of claim 22, further comprising:
a handle coupled to the receptacle; and
a power source disposed within the handle.

24. The fluid dispenser of claim 22, further comprising:
a cover constructed and arranged to cover the first opening, wherein the cover houses a power source; and
an ultraviolet light source mechanically coupled to the cover and electrically coupled to the power source.

25. The fluid dispenser of claim 21, wherein the receptacle comprises a water cooler.

26. The fluid dispenser of claim 21, wherein the receptacle comprises a refrigerator-mountable treatment device.

27. The fluid dispenser of claim 21, further comprising:
a first reservoir disposed between the first opening and the passage; and
a second reservoir disposed between the passage and the second opening.

28. The fluid dispenser of claim 27, wherein the ultraviolet light source is disposed within the passage.

29. The fluid dispenser of claim 27, wherein the ultraviolet light source is disposed within the first reservoir.

30. The fluid dispenser of claim 21, further comprising:
means for activating the ultraviolet light source in response to an indication of fluid in the receptacle.

31. The fluid dispenser of claim 30, wherein the means for activating comprises a pressure sensor for providing the indication.

32. The fluid dispenser of claim 31, wherein the means for activating further comprises an electrical switch coupled to the ultraviolet light source and responsive to the indication.

33. A bottle for holding and treating fluid, comprising:
a receptacle for holding the fluid;
a filtering unit constructed to be receivable within the receptacle, the filtering unit comprising a filter;
wherein the filtering unit is constructed such that insertion of the filtering unit into the receptacle causes fluid disposed within the receptacle to pass through the filter.

34. The bottle of claim 33, further comprising an ultraviolet light source disposed within the receptacle to disinfect fluid within the receptacle.

35. The bottle of claim 34, further comprising:
a coating disposed on an inner surface of the receptacle and/or filtering unit, wherein the coating is adapted to reflect ultraviolet light emitted by the ultraviolet light source.

36. The bottle of claim 34, further comprising:
a light detector; and
a switch to disable power to the ultraviolet light source when the light detector detects light.

37. The bottle of claim 33, further comprising a cap that is adapted to be coupled to the receptacle and/or the filtering unit to seal the bottle.

38. The bottle of claim 37, further comprising:
an ultraviolet light source coupled to the cap, wherein the ultraviolet light source is configured to irradiate fluid within the receptacle when the cap is coupled to the receptacle and/or the filtering unit.

39. The bottle of claim 38, further comprising:
a power source disposed within the cap, wherein the power source is electrically coupled to the ultraviolet light source.

40. The bottle of claim 38, further comprising: means for preventing activation of the ultraviolet light source when the cap is not coupled to the receptacle and/or the filtering unit.

41. The bottle of claim 34, further comprising:
means for deactiving the ultraviolet light source in response to an indication that a dosage of ultraviolet light sufficient to disinfect the fluid has been applied.

42. An improved-efficiency ultraviolet disinfection device, comprising:
a chamber; and
a black body radiator disposed within the chamber, wherein the black body radiator is adapted to emit light in the ultraviolet spectrum;
wherein at least a portion of the chamber is constructed and arranged to reflect an amount of light emitted by the black body radiator back toward the black body radiator such that the reflected light is incident upon the back body radiator; and
wherein the amount is sufficient to cause regenerative heating of the black body radiator.

43. The device of claim 42, wherein the black body radiator comprises a thermalized plasma.

44. A method of improving the efficiency of a black body radiator disposed within a housing and adapted to emit light in the ultraviolet spectrum, the method comprising acts of:
emitting light of both desirable and undesirable wavelengths from the black body radiator;
transmitting the light of desirable wavelengths through the housing;
reflecting the light of undesirable wavelengths off the housing and towards the black body radiator; and
using the reflected light of undesirable wavelengths, causing regenerative heating of the black body radiator.

45. The device of claim 44, wherein the light of desirable wavelengths comprises light in the ultraviolet spectrum, and wherein the light of undesirable wavelengths comprises light in the visible spectrum.

46. A replaceable module for a faucet-mountable treatment device, the module comprising:
a filter adapted to filter a fluid of at least some particulate matter and/or chemicals; and
a reflective material disposed on the filter, the reflective material adapted to reflect light in the ultraviolet range.
